(19) United States
(12) Patent Application Publication
(10) Pub. No.: US 2023/0382203 A1
(43) Pub. Date: Nov. 30, 2023

(54) VEHICLE DOOR DEVICE

(71) Applicant: AISIN CORPORATION, Kariya (JP)

(72) Inventors: Tomohito KIRYU, Kariya-shi (JP); Tatsuya SASO, Kariya-shi (JP)

(73) Assignee: AISIN CORPORATION, Kariya (JP)

(21) Appl. No.: 18/322,113

(22) Filed: May 23, 2023

(30) Foreign Application Priority Data
May 24, 2022 (JP) 2022-084634
Apr. 7, 2023 (JP) 2023-062656

(51) Int. Cl. B60J 5/04; E05D 15/28; E05B 83/38; E05F 15/63

(52) U.S. Cl. CPC B60J 5/0472; B60J 5/0477; E05Y 2900/531; E05B 83/38; E05F 15/63; E05D 15/28

(57) ABSTRACT

A vehicle door device includes first and second link arms each having a first pivot connection point with respect to a vehicle body and a second pivot connection point with respect to a door of a vehicle; a door side fitting portion provided at a closing side end portion of the door that opens and closes a door opening portion of the vehicle based on an operation of a link mechanism formed by the first and second link arms; and a vehicle body side fitting portion provided at a closing side end portion of the door opening portion with and from which the closing side end portion of the door comes in contact and separates based on an opening or closing operation of the door.

### CROSS REFERENCE TO RELATED APPLICATIONS

This application is based on and claims priority under 35 U.S.C. § 119 to Japanese Patent Application No. 2022-084634, filed on May 24, 2022, and Japanese Patent Application No. 2023-062656, filed on Apr. 7, 2023 the entire content of which is incorporated herein by reference.

### TECHNICAL FIELD

The present disclosure relates to a vehicle door device.

### BACKGROUND DISCUSSION

Conventionally, there is a vehicle door device including first and second link arms having a first pivot connection point with respect to a vehicle body and a second pivot connection point with respect to a door of a vehicle. In such a vehicle door device, the door provided in a door opening portion is opened and closed based on an operation of a link mechanism formed by the first and second link arms. In addition, for example, JP 2006-90097A describes a configuration in which each link arm forming a link mechanism is stored at a position outside a door opening mounted on a terminal portion of a vehicle body side portion and inside a weather strip mounted on a vehicle interior side of the door when the door is in a closed state. For example, JP 2008-163693A discloses a configuration in which this kind of a link mechanism formed by each link arm is combined with a structure in which a guide rail on the vehicle body side and a guide roller unit on the door side are engaged with each other.

However, in the configuration in which the door of the vehicle is supported by the vehicle body via the link mechanism formed by the first and second link arms as described above, in a case where the door is in the vicinity of the fully closed position, the distance between the first and second link arms becomes short, and the first and second link arms tend to be in a linearly arranged state. Therefore, there is a problem in that it is difficult to stably support the door at the fully closed position.

A need thus exists for a vehicle door device which is not susceptible to the drawback mentioned above.

### SUMMARY

A vehicle door device includes: first and second link arms each having a first pivot connection point with respect to a vehicle body and a second pivot connection point with respect to a door of a vehicle; a door side fitting portion provided at a closing side end portion of the door that opens and closes a door opening portion of the vehicle based on an operation of a link mechanism formed by the first and second link arms; and a vehicle body side fitting portion provided at a closing side end portion of the door opening portion with and from which the closing side end portion of the door comes in contact and separates based on an opening or closing operation of the door; wherein one side of the door side fitting portion and the vehicle body side fitting portion includes a male fitting member having a fitting protrusion protruding in a direction in which the closing side end portion of the door and the closing side end portion of the door opening portion come in contact with and separate from each other; the other side of the door side fitting portion and the vehicle body side fitting portion includes a female fitting member having a fitting recess into and from which the fitting protrusion is inserted and removed based on an opening or closing operation of the door; and when the door is at a fully closed position, the male fitting member and the female fitting member are fitted to each other, so that relative displacement in a direction intersecting an insertion or removal direction of the fitting protrusion with respect to the fitting recess can be restricted.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a front view of a door provided in a door opening portion of a vehicle;

FIG. 2 is a front view of a door provided in a door opening portion of a vehicle;

FIG. 3 is a top view of a door device that opens and closes a door of the vehicle;

FIG. 4 is a perspective view of a door device that opens and closes a door of a vehicle;

FIG. 5 is a plan view of an joint link mechanism constituting a variable connection length mechanism;

FIG. 6 is a plan view of an joint link mechanism constituting a variable connection length mechanism;

FIG. 7 is an explanatory view illustrating an opening or closing operation trajectory of a door in the vicinity of a fully closed position;

FIG. 8 is a schematic configuration diagram of a door side engagement portion and a vehicle body side engagement portion;

FIG. 9 is a schematic configuration diagram of a vehicle illustrating an arrangement of a door side engagement portion and a door side fitting portion, and a vehicle body side engagement portion and a vehicle body side fitting portion;

FIG. 10 is a perspective view of an upper vehicle body side fitting portion and an upper vehicle body side engagement portion provided at an upper edge portion of the door opening portion;

FIG. 11 is a perspective view of an upper door side fitting portion and an upper door side engagement portion provided at a front end portion of the door;

FIG. 12 is a plan view of an upper vehicle body side fitting portion and an upper vehicle body side engagement portion, and an upper door side fitting portion and an upper door side engagement portion;

FIG. 13 is a plan view of an upper vehicle body side fitting portion and an upper vehicle body side engagement portion, and an upper door side fitting portion and an upper door side engagement portion;

FIG. 14 is a side view of an upper vehicle body side fitting portion and an upper vehicle body side engagement portion, and an upper door side fitting portion and an upper door side engagement portion;

FIG. 15 is a cross-sectional view of an upper vehicle body side fitting portion and an upper door side fitting portion;

FIG. 16 is a perspective view of a lower vehicle body side fitting portion and a lower vehicle body side engagement portion provided at a lower edge portion of the door opening portion;

FIG. 17 is a perspective view of a lower door side fitting portion and a lower door side engagement portion provided at a front end portion of the door;

FIG. 18 is a plan view of a lower vehicle body side fitting portion and a lower vehicle body side engagement portion, and a lower door side fitting portion and a lower door side engagement portion;

FIG. 19 is a plan view of a lower vehicle body side fitting portion and a lower vehicle body side engagement portion, and a lower door side fitting portion and a lower door side engagement portion;

FIG. 20 is a side view of a lower vehicle body side fitting portion and a lower vehicle body side engagement portion, and a lower door side fitting portion and a lower door side engagement portion;

FIG. 21 is a cross-sectional view of a lower vehicle body side fitting portion and a lower door side fitting portion;

FIG. 22 is an exploded perspective view of an upper door side fitting portion and an upper door side engagement portion;

FIG. 23 is an exploded perspective view of a lower door side fitting portion and a lower door side engagement portion;

FIG. 24 is a side view of an upper door side fitting portion and an upper vehicle body side fitting portion; and

FIG. 25 is a side view of the lower door side fitting portion and the lower vehicle body side fitting portion.

### DETAILED DESCRIPTION

Hereinafter, an embodiment of a vehicle door device will be described with reference to the drawings.

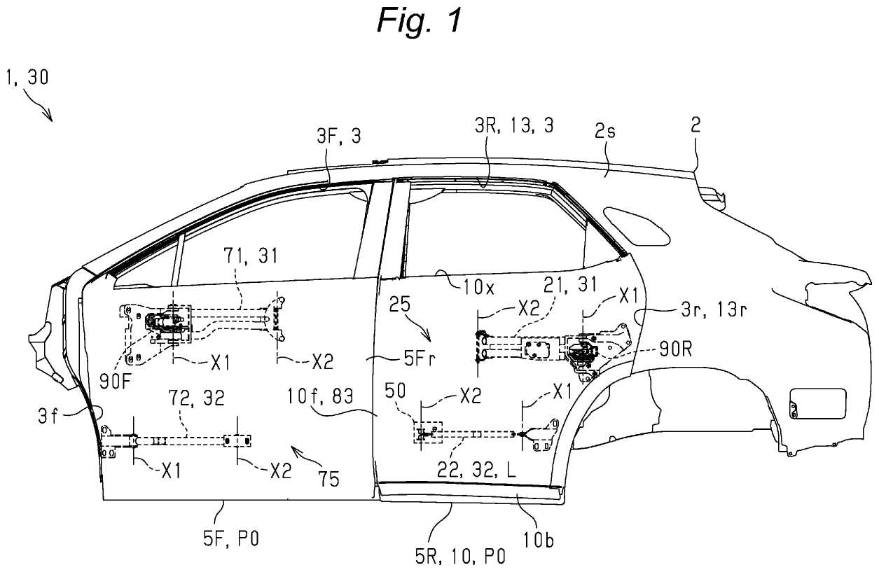

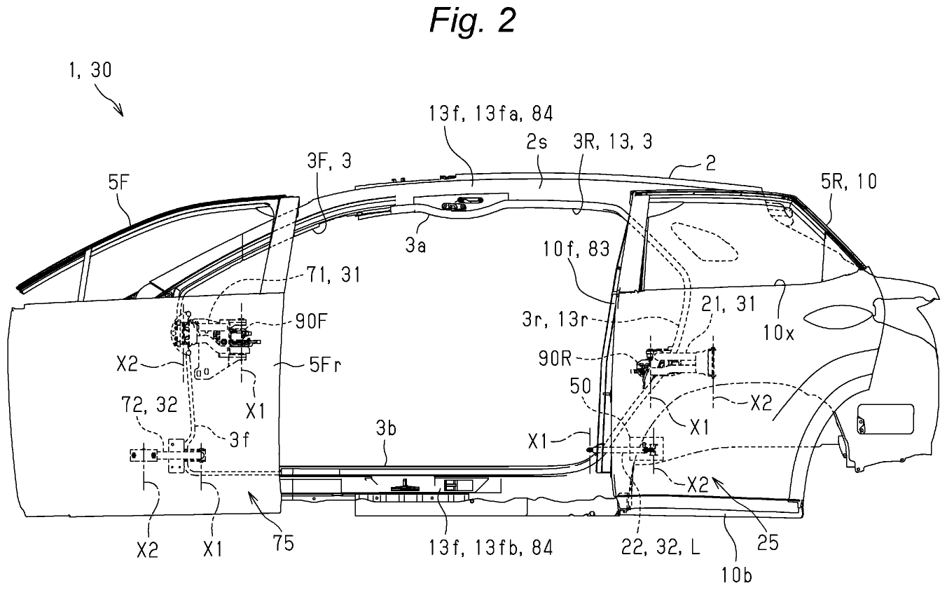

As illustrated in FIGS. 1 to 4, a vehicle 1 of the present embodiment has a door opening portion 3 provided on a side surface 2s of a vehicle body 2. In the vehicle 1 of the present embodiment, the door opening portion 3 does not have a pillar structure at a central portion in a vehicle front-rear direction (left-right direction in each drawing), but has a so-called pillarless structure in which a front opening portion 3F and a rear opening portion 3R are integrated. That is, in the vehicle 1 of the present embodiment, a front door 5F is provided in the front opening portion 3F of the door opening portion 3, and a rear door 5R is provided in the rear opening portion 3R. Note that hereinafter, for convenience of description, the rear door 5R is referred to as a door 10 of the vehicle 1, and the rear opening portion 3R of the door opening portion 3 provided with the door 10 is referred to as a door opening portion 13. In addition, the vehicle 1 of the present embodiment includes first and second link arms 21 and 22 provided in the door opening portion 13. In the vehicle 1 of the present embodiment, a vehicle door device 30 is formed that opens and closes the door 10 of the vehicle 1 provided in the door opening portion 13 based on an operation of a link mechanism 25 formed by the first and second link arms 21 and 22.

More specifically, each of the first and second link arms 21 and 22 has first pivot connection points X1 and X1 rotatably connected to the vehicle body 2 in a vicinity of a rear edge portion 13r of the door opening portion 13. Furthermore, each of the first and second link arms 21 and 22 has second pivot connection points X2 and X2 rotatably connected to the door 10. The vehicle door device 30 according to the present embodiment thus has a configuration in which the first and second link arms 21 and 22 form the link mechanism 25 having a configuration as a four-bar link.

In the vehicle door device 30 according to the present embodiment, the first link arm 21 is disposed above the second link arm 22. Specifically, each of the first link arms 21 is disposed at a height below a window portion 10x provided in the door 10, that is, near a so-called belt line. Each of the second link arms 22 is disposed at a height near a lower end portion 10b of the door 10.

That is, in the vehicle door device 30 of the present embodiment, the first link arm 21 has the second pivot connection point X2 at a position closer to the center of gravity of the door 10 than the second link arm 22. Thus, the vehicle door device 30 according to the present embodiment is configured such that the first link arm 21 supports a larger door load than the second link arm 22.

Specifically, in the vehicle door device 30 of the present embodiment, each of the first link arms 21 positioned as a main link 31 is formed by connecting two parallel shaft-shaped members. On the other hand, each of the second link arms 22 positioned as a sub-link 32 is formed using one shaft-shaped member. Thus, the vehicle door device 30 of the present embodiment is configured to impart a high degree of support rigidity to the first link arms 21.

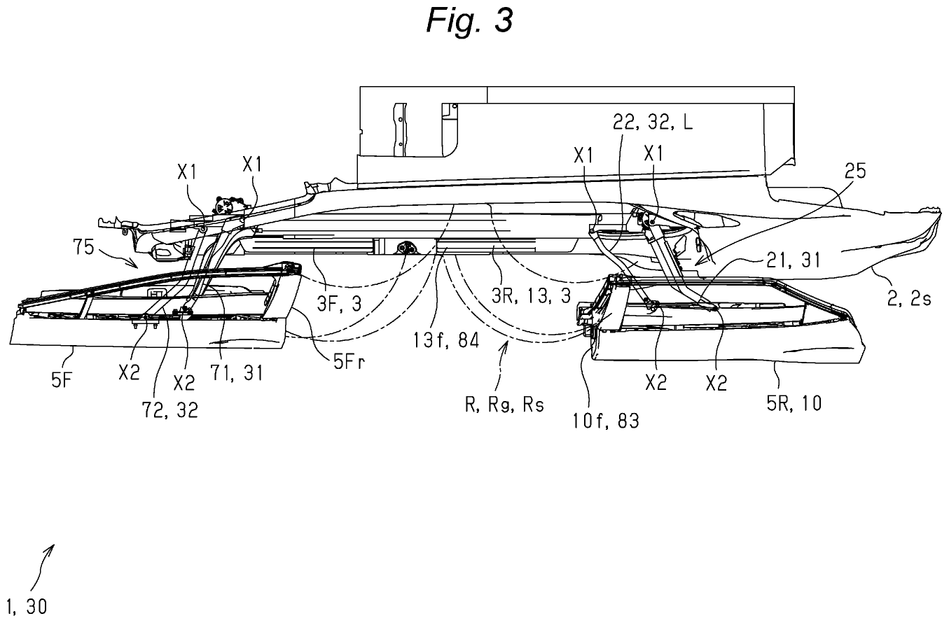

More specifically, as illustrated in FIG. 3, in the vehicle door device 30 of the present embodiment, when the door 10 is opened, the first and second link arms 21 and 22 of the link mechanism 25 rotate in the counterclockwise direction in FIG. 3 around the first pivot connection point X1. Thus, in the vehicle door device 30 according to the present embodiment, the door 10 supported by the first and second link arms 21 and 22 performs an opening operation toward the vehicle rear side.

Furthermore, in the vehicle door device 30 of the present embodiment, when the door 10 is closed, the first and second link arms 21 and 22 rotate in the clockwise direction in FIG. 3 around the first pivot connection point X1. Thus, the vehicle door device 30 of the present embodiment is configured such that the door 10 supported by the first and second link arms 21 and 22 performs a closing operation toward the vehicle front side.

That is, in the vehicle door device 30 of the present embodiment, an opening or closing operation trajectory R of the door 10 is defined so as to draw an arc-shaped trajectory Rg based on the operation of the link mechanism 25 formed by the first and second link arms 21 and 22. That is, when the door 10 is in the vicinity of a fully closed position P0, the first and second link arms 21 and 22 forming the link mechanism 25 extend in the vehicle front-rear direction. Thus, in the vehicle door device 30 of the present embodiment, a moving component of the door 10 in the vehicle width direction increases.

In addition, at an intermediate opening or closing operation position where the first and second link arms 21 and 22 forming the link mechanism 25 extend in the vehicle width direction, a moving component of the door 10 in the vehicle front-rear direction increases. The vehicle door device 30 of the present embodiment thus has a configuration capable of avoiding interference with an obstacle and securing a larger door opening amount by suppressing a displacement amount in the vehicle width direction at the time of the opening or closing operation of the door 10.

(Variable Connection Length Mechanism)

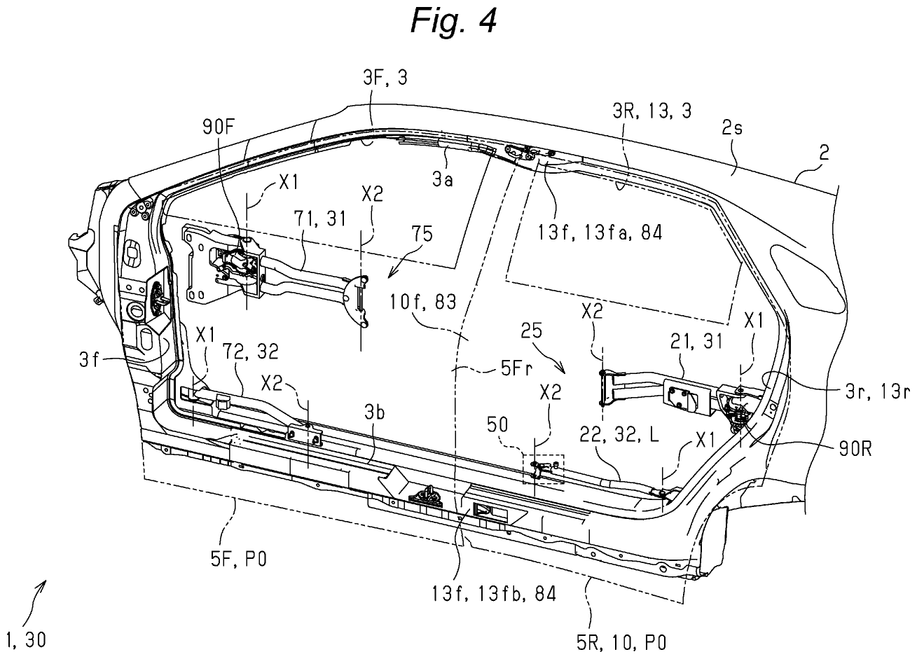

As illustrated in FIGS. 4 to 6, the vehicle door device 30 of the present embodiment includes a variable connection length mechanism 50 provided on the second link arm 22. Based on the operation of the variable connection length mechanism 50, a connection length L between the first and second pivot connection points X1 and X2 can be changed.

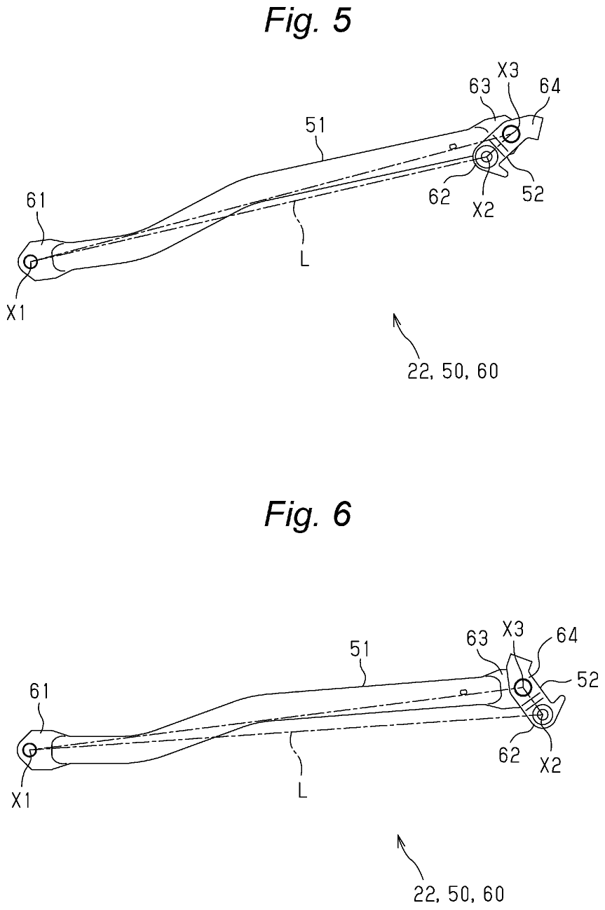

More specifically, as illustrated in FIGS. 5 and 6, in the vehicle door device 30 of the present embodiment, the second link arm 22 includes a vehicle body side link 51 and a door side link 52. That is, the vehicle body side link 51 has the first pivot connection point X1 with respect to the vehicle body 2. In addition, the door side link 52 has the second pivot connection point X2 with respect to the door 10 of the vehicle 1. Furthermore, the second link arm 22 has a configuration in which the vehicle body side link 51 and the door side link 52 are rotatably connected. The vehicle door device 30 of the present embodiment is configured such that a joint link mechanism 60 formed by this functions as the variable connection length mechanism 50.

Specifically, the door side link 52 of the present embodiment has a configuration as a so-called mini arm having a short axial length in comparison with the vehicle body side link 51. In addition, the vehicle body side link 51 has a vehicle body side connecting portion 61 with respect to the vehicle body 2 at one end side in the lengthwise direction thereof. Further, the door side link 52 also has a door side connecting portion 62 with respect to the door 10 at one end side in the lengthwise direction thereof. The vehicle body side link 51 and the door side link 52 have intermediate connecting portions 63 and 64 connected to each other at the other end side in the lengthwise direction.

That is, in the vehicle door device 30 of the present embodiment, the intermediate connecting portions 63 and 64 form an intermediate connection point X3 of the joint link mechanism provided in the second link arm 22. In addition, in the second link arm 22, the vehicle body side link 51 and the door side link 52 form a triangle with the intermediate connection point X3 as a vertex. As a result, the vehicle body side link 51 and the door side link 52 relatively rotate, so that the length of the straight line connecting the first and second pivot connection points X1 and X2, which are the bases of the triangle, that is, the connection length L thereof changes.

In the vehicle door device 30 of the present embodiment, a biasing member (not illustrated) applies a biasing force to the joint link mechanism 60 constituting the variable connection length mechanism 50 to relatively rotate the vehicle body side link 51 and the door side link 52 around the intermediate connection point X3. That is, the variable connection length mechanism 50 of the present embodiment is biased in a direction of shortening the connection length L of the door by the second link arm 22 provided with the variable connection length mechanism 50. Thus, the vehicle door device 30 of the present embodiment is configured such that the door 10 opens and closes in a state where the connection length L by the second link arm 22 is shortened except when the door 10 described in detail below is in the vicinity of the fully closed position P0.

As illustrated in FIGS. 4 to 7, in the vehicle door device 30 of the present embodiment, the opening or closing operation trajectory R of the door 10 changes based on the operation of the variable connection length mechanism 50 provided in the second link arm 22. Specifically, when the door 10 is in the vicinity of the fully closed position P0, the opening or closing operation trajectory R of the door 10 changes to a linear trajectory Rs. Thus, the vehicle door device 30 of the present embodiment is configured such that the door 10, as the rear door 5R, does not interfere with the front door 5F provided in the front opening portion 3F of the door opening portion 3 side by side with the door 10.

As illustrated in FIGS. 1 to 4, in the vehicle 1, similarly to the door 10 constituting the rear door 5R, the front door 5F is also supported by the front opening portion 3F of the door opening portion 3 by a link mechanism 75 formed by the first and second link arms 71 and 72. Specifically, each of the first and second link arms 71 and 72 has first pivot connection points X1 and X1 with respect to the vehicle body 2 in the vicinity of the front edge portion 3f of the door opening portion 3. The front door 5F of the present embodiment is configured to perform an opening operation toward the vehicle front side and a closing operation toward the vehicle rear side based on the operation of the link mechanism 75.

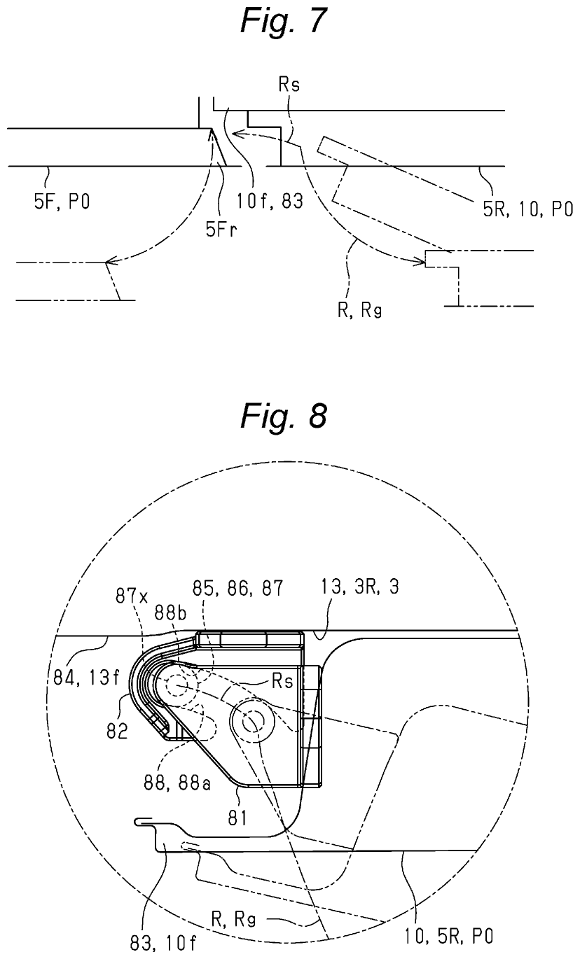

More specifically, as illustrated in FIG. 7, when the door 10 of the present embodiment is at the fully closed position P0, the front end portion 10f thereof is disposed farther inside in the vehicle width direction than the rear end portion 5Fr of the front door 5F also at the fully closed position P0. For this reason, when it is assumed that the opening or closing operation is performed in an arc-shaped trajectory Rg based on the rotation of the first and second link arms 21 and 22 even in the vicinity of the fully closed position P0, there arises a problem that the front end portion 10f of the door 10 interferes with the rear end portion 5Fr of the front door 5F.

In view of this point, in the vehicle door device 30 of the present embodiment, when the door 10 is in the vicinity of the fully closed position P0 as described above, the opening or closing operation trajectory R of the door 10 changes based on the operation of the variable connection length mechanism 50. Specifically, at the time of the full-closing operation of the door 10, the door 10 moves in a mode in which the front end portion 10f draws a linear trajectory Rs from the vehicle rear side toward the vehicle front side (from the right side to the left side in FIG. 7). In addition, at the time of the opening operation from the fully closed position P0, the door 10 similarly moves in a mode in which the front end portion 10f draws a linear trajectory Rs from the vehicle front side toward the vehicle rear side (from the left side to the right side in FIG. 7). The vehicle door device 30 according to the present embodiment thus enables the door 10 configured as the rear door 5R to independently perform an opening or closing operation regardless of the operation position of the front door 5F.

(Door Side Engagement Portion and Vehicle Body Side Engagement Portion)

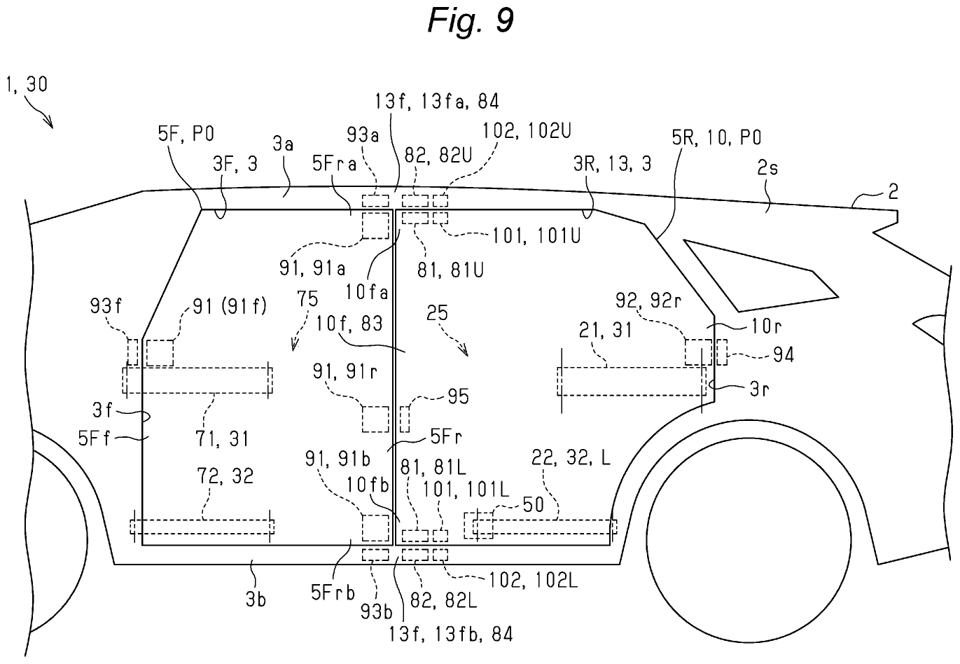

More specifically, as illustrated in FIGS. 8 and 9, the vehicle door device 30 of the present embodiment includes a door side engagement portion 81 provided at the front end portion 10f of the door 10 and a vehicle body side engagement portion 82 provided at the front edge portion 13f of the door opening portion 13.

That is, in the vehicle 1 of the present embodiment, the door side engagement portion 81 is provided at a closing side end portion 83 located on a closing operation side of the door 10 that opens and closes the door opening portion 13 based on the operation of the link mechanism 25 formed by the first and second link arms 21 and 22. Further, the vehicle body side engagement portion 82 is provided at a closing side end portion 84 of the door opening portion 13 where the closing side end portion 83 of the door 10 comes into contact with or separates from, that is, approaches or separates from, based on the opening or closing operation of the door 10 moving in the vehicle front-rear direction.

Note that, in the vehicle 1 of the present embodiment, the substantially central position in the opening width direction of the door opening portion 3 having a so-called pillarless structure and extending in the vehicle front-rear direction is the front edge portion 13f of the door opening portion 13 located in the rear opening portion 3R. The vehicle door device 30 of the present embodiment is configured such that the door side engagement portion 81 and the vehicle body side engagement portion 82 are engaged with each other in a state where the door 10 is in the vicinity of the fully closed position P0.

Specifically, as illustrated in FIG. 9, the door 10 of the present embodiment has an upper door side engagement portion 81U provided at an upper end portion 10fa of the door 10 and a lower door side engagement portion 81L provided at a lower end portion 10fb at the front end portion 10f which is the closing side end portion 83 of the door 10. The door opening portion 13 provided with the door 10 also includes an upper vehicle body side engagement portion 82U provided at an upper edge portion 13fa and a lower vehicle body side engagement portion 82L provided at a lower edge portion 13fb.

As illustrated in FIG. 8, the door side engagement portion 81 of the present embodiment includes, as a guide engagement portion 85, a shaft-shaped engagement portion 86 extending in the vertical direction (a direction orthogonal to the paper surface in FIG. 8) of the vehicle 1. Note that in the vehicle door device 30 of the present embodiment, the shaft-shaped engagement portion 86, as the guide engagement portion 85, has a configuration as a roller 87 rotatably supported around a support shaft 87x extending in the vertical direction. Further, the vehicle body side engagement portion 82 includes a guide groove 88 having a pair of side wall portions 88a and 88b facing each other in the vehicle width direction (the vertical direction in FIG. 8) and extending in the opening or closing operation direction of the door 10. Thus, the vehicle door device 30 of the present embodiment is configured such that the door side engagement portion 81 and the vehicle body side engagement portion 82 are engaged with each other in a state where the guide engagement portion 85 and the roller 87 as the shaft-shaped engagement portion 86 are disposed in the guide groove 88.

That is, the shaft-shaped engagement portion 86 of the door side engagement portion 81 is disposed in the guide groove 88 of the vehicle body side engagement portion 82 in a state of being sandwiched between the pair of side wall portions 88a and 88b facing each other in the vehicle width direction, whereby displacement of the door 10 in the vehicle width direction is restricted. Thus, the vehicle door device 30 of the present embodiment can stably support the door 10 even in the vicinity of the fully closed position P0 where the first and second link arms 21 and 22 forming the link mechanism 25 are likely to be in an aligned state.

Furthermore, in the vehicle door device 30 of the present embodiment, the opening or closing operation of the door 10 in a state where the door side engagement portion 81 and the vehicle body side engagement portion 82 are engaged with each other is allowed based on the operation of the variable connection length mechanism 50 provided in the second link arm 22. Specifically, when the door 10 is opened and closed in a state where the door side engagement portion 81 and the vehicle body side engagement portion 82 are engaged with each other, the roller 87, as the guide engagement portion 85, is relatively displaced along the extending direction of the guide groove 88 together with the change of the connection length L based on the operation of the variable connection length mechanism 50. That is, in the vehicle door device 30 of the present embodiment, when the door 10 moves to the fully closed position P0, the door side engagement portion 81 is engaged with the vehicle body side engagement portion 82, so that the opening or closing operation of the door is guided in a state where the roller 87 is disposed in the guide groove 88. Thus, in the vehicle door device 30 of the present embodiment, the opening or closing operation trajectory R of the door changes. That is, the arc-shaped trajectory Rg based on the operation of the link mechanism 25 is changed to the linear trajectory Rs along the opening width direction of the door opening portion 13.

(Actuator)

As illustrated in FIGS. 1 to 4, the vehicle door device 30 of the present embodiment has a configuration as a so-called power door device that has a drive source and opens and closes the door 10 of the vehicle 1.

More specifically, the vehicle door device 30 of the present embodiment includes an actuator 90R provided at a proximal end portion of the first link arm 21 among the first and second link arms 21 and 22 forming the link mechanism 25. Specifically, the actuator 90R uses a motor (not illustrated) as a drive source. Furthermore, the actuator 90R rotationally drives the first link arm 21 around the first pivot connection point X1 with respect to the vehicle body 2 in a state of being fixed to the vehicle body 2. Thus, the vehicle door device 30 of the present embodiment is configured such that the door 10 supported by the link mechanism 25, that is, the rear door 5R of the vehicle 1 is opened and closed based on the driving force of the actuator 90R.

Note that in the vehicle door device 30 of the present embodiment, a similar actuator 90F is provided in the link mechanism 75 that supports the front door 5F of the vehicle 1. That is, the actuator 90F also rotationally drives the first link arm 71 around the first pivot connection point X1 with respect to the vehicle body 2 using a motor (not illustrated) as a drive source. Thus, the vehicle door device 30 of the present embodiment is configured such that the front door 5F similarly performs the opening or closing operation based on the driving force of the actuator 90F.

(Locking Device)

As illustrated in FIG. 9, in the vehicle 1 of the present embodiment, the front door 5F is provided with a plurality of locking devices 91 that restrain the front door 5F at the fully closed position P0. Further, the door 10 constituting the rear door 5R of the vehicle 1 is also provided with a locking device 92 that restrains the door 10 at the fully closed position P0. Thus, the vehicle 1 of the present embodiment is configured to stably maintain the front door 5F and the rear door 5R provided in the door opening portion 3 at the fully closed position P0.

Specifically, the front door 5F of the present embodiment includes a locking device 91f provided at the front end portion 5Ff, a locking device 91a provided at an upper end 5Fra of the rear end portion 5Fr, and a locking device 91b provided at a lower end 5Frb of the rear end portion 5Fr. Further, the front door 5F includes a locking device 91r provided at the rear end portion 5Fr. The door 10, as the rear door 5R, includes a locking device 92r provided at the rear end portion 10r.

That is, when the front door 5F moves to the fully closed position P0, the locking device 91f provided at the front end portion 5Ff of the front door 5F engages with a striker 93f provided at the front edge portion 3f of the door opening portion 3. The vehicle 1 of the present embodiment restrains the front end portion 5Ff of the front door 5F at the front edge portion 3f of the door opening portion 3 based on the engagement force of the locking device 91f and the striker 93f.

Further, the locking devices 91a and 91b provided at the rear end portion 5Fr of the front door 5F are also engaged with the strikers 93a and 93b respectively provided at the upper edge portion 3a and the lower edge portion 3b of the door opening portion 3 when the front door 5F similarly moves to the fully closed position P0. The vehicle 1 of the present embodiment restrains the rear end portion 5Fr, the upper end 5Fra, and the lower end 5Frb of the front door 5F to the upper edge portion 3a and the lower edge portion 3b of the door opening portion 3 based on the engagement forces of the locking devices 91a and 91b and the strikers 93a and 93b.

The locking device 92r provided at the rear end portion 10r of the door 10 constituting the rear door 5R is engaged with the striker 94 provided at the rear edge portion 3r of the door opening portion 3 when the door 10 moves to the fully closed position P0. The vehicle 1 of the present embodiment restrains the rear end portion 10r of the door 10 to the rear edge portion 3r of the door opening portion 3 based on the engagement force of the locking device 92r and the striker 94.

Here, in the vehicle 1 of the present embodiment, the striker 95 is provided at the front end portion 10f of the door 10 constituting the rear door 5R. Further, when the door 10 moves to the fully closed position P0, the striker 95 engages with a locking device 91r provided at the rear end portion 5Fr of the front door 5F. The vehicle 1 of the present embodiment is configured to restrain the rear end portion 5Fr of the front door 5F and the front end portion 10f of the door 10 to be the rear door 5R based on the engagement force of the striker 95 and the locking device 91r.

(Fully Closed Position Door Support Structure)

Next, a support structure of the door 10 at the fully closed position P0 mounted in the vehicle door device 30 of the present embodiment will be described.

As illustrated in FIG. 9, the vehicle door device 30 of the present embodiment includes the door side engagement portion 81 and the vehicle body side engagement portion 82, and a door side fitting portion 101 and a vehicle body side fitting portion 102 respectively provided at a closing side end portion 83 of the door 10 and a closing side end portion 84 of the door opening portion 13. Furthermore, in the vehicle door device 30 of the present embodiment, the door side fitting portion 101 and the vehicle body side fitting portion 102 are fitted to each other and released from the fitting based on the opening or closing operation of the door 10. Thus, the vehicle door device 30 of the present embodiment is configured such that when the door 10 is at the fully closed position P0, the relative displacement of the door 10 with respect to the vehicle body 2 is restricted based on the fitted state of the door side fitting portion 101 and the vehicle body side fitting portion 102.

Specifically, the door 10 of the present embodiment, at the front end portion 10f, which is the closing side end portion 83 of the door 10, has an upper door side fitting portion 101U provided at the upper end portion 10fa of the door 10 and a lower door side fitting portion 101L provided at the lower end portion 10fb. The door opening portion 13 provided with the door 10 also similarly includes an upper vehicle body side fitting portion 102U provided at the upper edge portion 13fa and a lower vehicle body side fitting portion 102L provided at the lower edge portion 13fb. Furthermore, in the vehicle 1 of the present embodiment, the upper door side fitting portion 101U and the lower door side fitting portion 101L are provided at positions aligned with the upper door side engagement portion 81U and the lower door side engagement portion 81L, respectively. The upper vehicle body side fitting portion 102U and the lower vehicle body side fitting portion 102L are also provided at positions aligned with the upper vehicle body side engagement portion 82U and the lower vehicle body side engagement portion 82L.

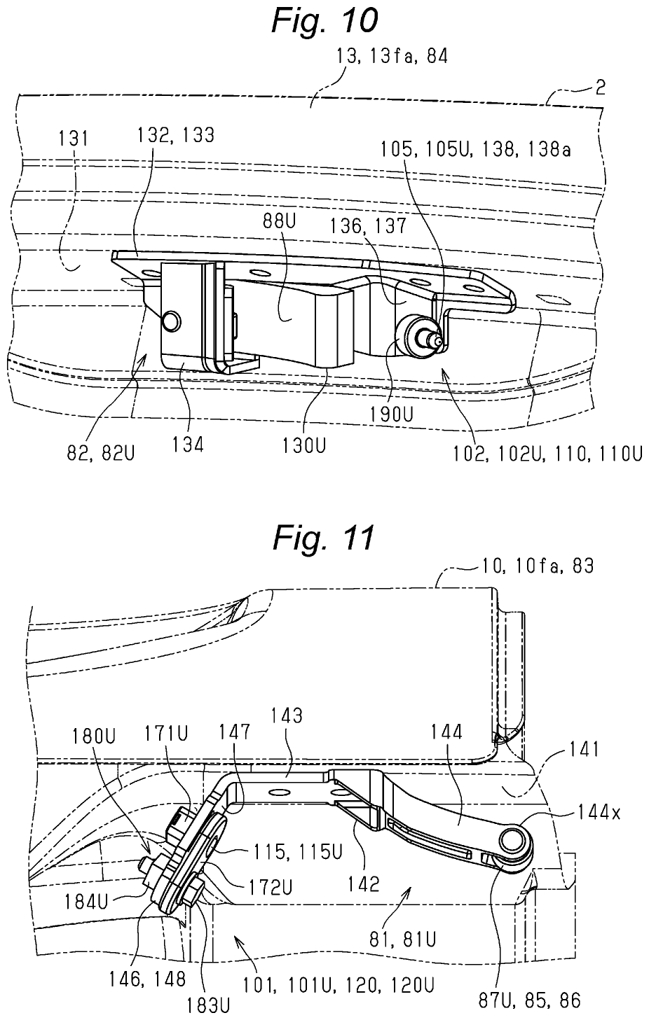

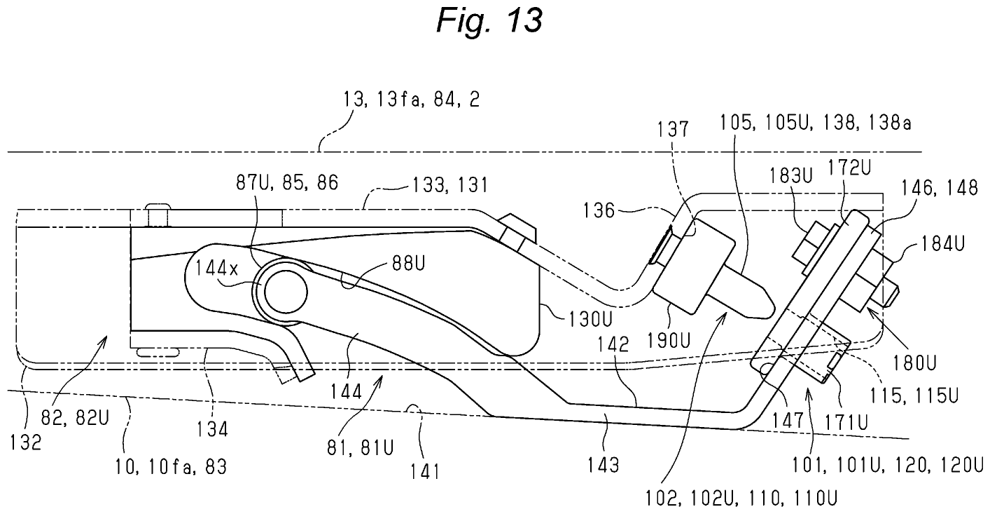

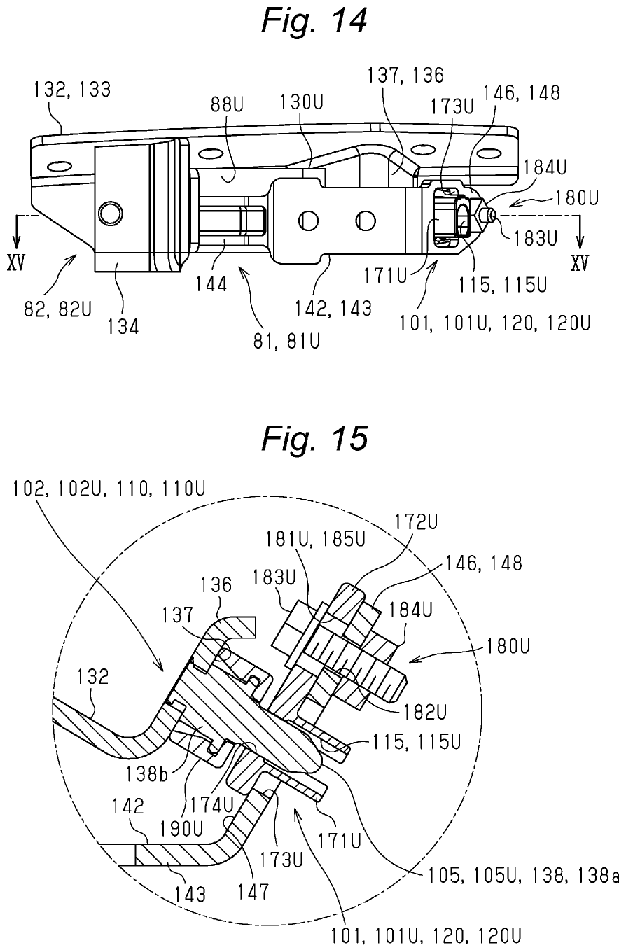

More specifically, as illustrated in FIGS. 10 to 15, the upper vehicle body side fitting portion 102U includes a male fitting member 110U having a fitting protrusion 105U. In addition, the upper door side fitting portion 101U includes a female fitting member 120U having a fitting recess 115U into and from which the fitting protrusion 105U is inserted and removed based on the opening or closing operation of the door 10. Further, in the vehicle door device 30 of the present embodiment, the vehicle body side fitting portion 102U is integrally formed with the upper vehicle body side engagement portion 82U. The upper door side fitting portion 101U is also integrally formed with the upper door side engagement portion 81U.

More specifically, the vehicle door device 30 of the present embodiment includes a guide member 130U forming the guide groove 88U for the upper vehicle body side engagement portion 82U. The vehicle door device 30 of the present embodiment includes a bracket 132 that supports the guide member 130U on an installation surface 131 set at the upper edge portion 13fa of the door opening portion 13.

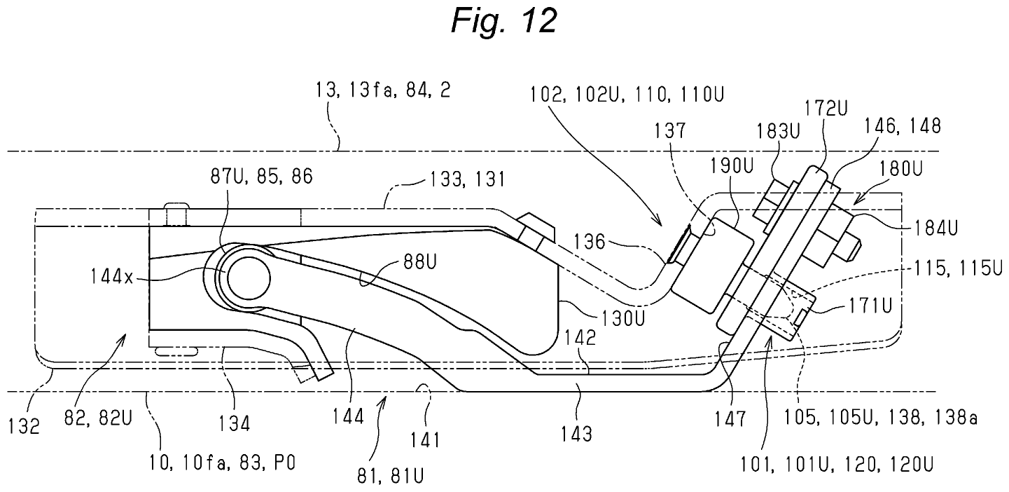

In the vehicle door device 30 of the present embodiment, the bracket 132 includes a base member 133 fixed to the installation surface 131, and a holder member 134 having a substantially U-shaped cross-sectional shape and fixed to one end (end portion on the left side in FIG. 12) of the base member 133. The bracket 132 of the present embodiment is configured to support the guide member 130U on the installation surface 131 so as to be sandwiched between the base member 133 and the holder member 134.

In addition, the base member 133 of the present embodiment has an extending portion 136 extending from a position where the guide member 130U is supported toward the vehicle rear side (the right side in FIG. 12). Furthermore, the extending portion 136 forms a support surface 137 facing the extending direction of the guide groove 88U formed by the guide member 130U, that is, the direction in which the closing side end portion 83 of the door 10 and the closing side end portion 84 of the door opening portion 13 come into contact with and separate from each other (lower right side in FIG. 12) based on the opening or closing operation of the door 10. The vehicle door device 30 of the present embodiment includes a shaft-shaped engagement pin 138 supported by the extending portion 136 of the bracket 132 so as to protrude from the support surface 137.

Specifically, in the vehicle door device 30 of the present embodiment, the engagement pin 138 is provided such that a distal end portion 138a thereof protrudes in a direction in which the closing side end portion 83 of the door 10 and the closing side end portion 84 of the door opening portion 13 come into contact with and separate from each other. The vehicle door device 30 of the present embodiment has a configuration in which the distal end portion 138a of the engagement pin 138 is used as the fitting protrusion 105U of the male fitting member 110U, and the vehicle body side fitting portion 102U is formed thereover.

As described above, in the vehicle door device 30 of the present embodiment, the upper vehicle body side engagement portion 82U and the upper vehicle body side fitting portion 102U support the guide member 130U and the male fitting member 110U on the installation surface 131 in a mode in which the bracket 132 is shared. Thus, the vehicle door device 30 of the present embodiment has a configuration in which the upper vehicle body side engagement portion 82U and the upper vehicle body side fitting portion 102U are integrated.

On the other hand, the upper door side engagement portion 81U includes a support member 142 that supports a roller 87U, as the guide engagement portion 85, with respect to the installation surface 141 set at the upper end portion 10fa of the door 10. Specifically, the support member 142 includes a fixing portion 143 with respect to the installation surface 141 and a support arm 144 that supports the roller 87U at a distal end 144x thereof. In the vehicle door device 30 of the present embodiment, the fixing portion 143 has a substantially flat outer shape. In addition, the support arm 144 has an elongated shape extending from the fixing portion 143 toward the vehicle front side in a state where the fixing portion 143 is fixed to the installation surface 141. Furthermore, in the door side engagement portion 81U of the present embodiment, the support arm 144 has a curved elongated shape corresponding to a groove shape of the guide groove 88U that is curved and extending from the vehicle rear side toward the front in the front-rear direction. Thus, the upper door side fitting portion 101U is configured such that the roller 87U enters into the guide groove 88U based on the closing operation of the door 10 moving to the fully closed position P0 without the support arm 144 interfering with the guide member 130U.

In addition, the support member 142 of the present embodiment has an extending portion 146 extending from the fixing portion 143 toward the vehicle rear side. Further, the extending portion 146 forms a support surface 147 facing in a direction in which the support arm 144 protrudes from the fixing portion 143, that is, the direction in which the closing side end portion 83 of the door 10 and the closing side end portion 84 of the door opening portion 13 come into contact with and separate from each other (upper left side in FIG. 12) based on the opening or closing operation of the door 10. The vehicle door device 30 of the present embodiment is configured such that the upper door side fitting portion 101U is formed by fixing the female fitting member 120U to the extending portion 146 of the support member 142.

That is, the female fitting member 120U of the present embodiment has the fitting recess 115U extending in a direction substantially orthogonal to the support surface 147 formed by the extending portion 146 in a state of being fixed to the extending portion 146 of the support member 142. Thus, the vehicle door device 30 of the present embodiment is configured such that the fitting protrusion 105U of the male fitting member 110U constituting the vehicle body side fitting portion 102U is inserted into and removed from the fitting recess 115U of the female fitting member 120U based on the opening or closing operation of the door 10.

As described above, in the vehicle door device 30 of the present embodiment, the guide engagement portion 85 and the female fitting member 120U are supported on the installation surface 141 in a mode in which the upper door side fitting portion 101U shares a part of the support member 142 constituting the upper door side engagement portion 81U. That is, the upper door side fitting portion 101U is configured to use the extending portion 146 of the support member 142 for the bracket 148 that supports the female fitting member 120U on the installation surface 141. Thus, the vehicle door device 30 of the present embodiment has a configuration in which the upper door side engagement portion 81U and the upper door side fitting portion 101U are integrated.

Furthermore, in the vehicle door device 30 according to the present embodiment, the upper door side engagement portion 81U and the upper vehicle body side engagement portion 82U are engaged in the state where the roller 87U to be the guide engagement portion 85 is disposed in the guide groove 88U as described above. The vehicle door device 30 of the present embodiment is configured such that the fitting protrusion 105U of the male fitting member 110U and the fitting recess 115U of the female fitting member 120U are inserted and removed in a state where the opening or closing operation of the door 10 is guided.

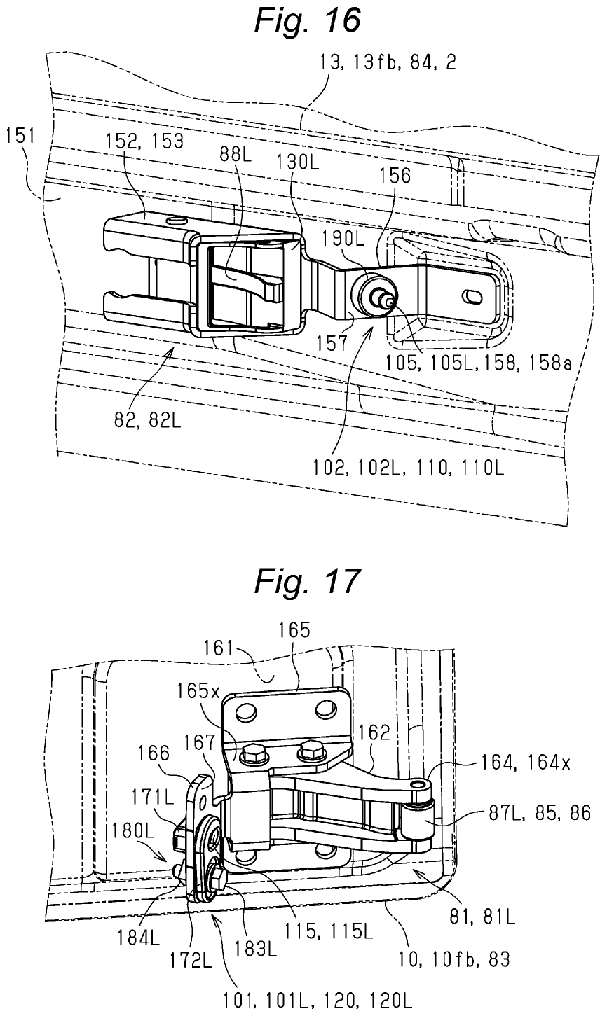

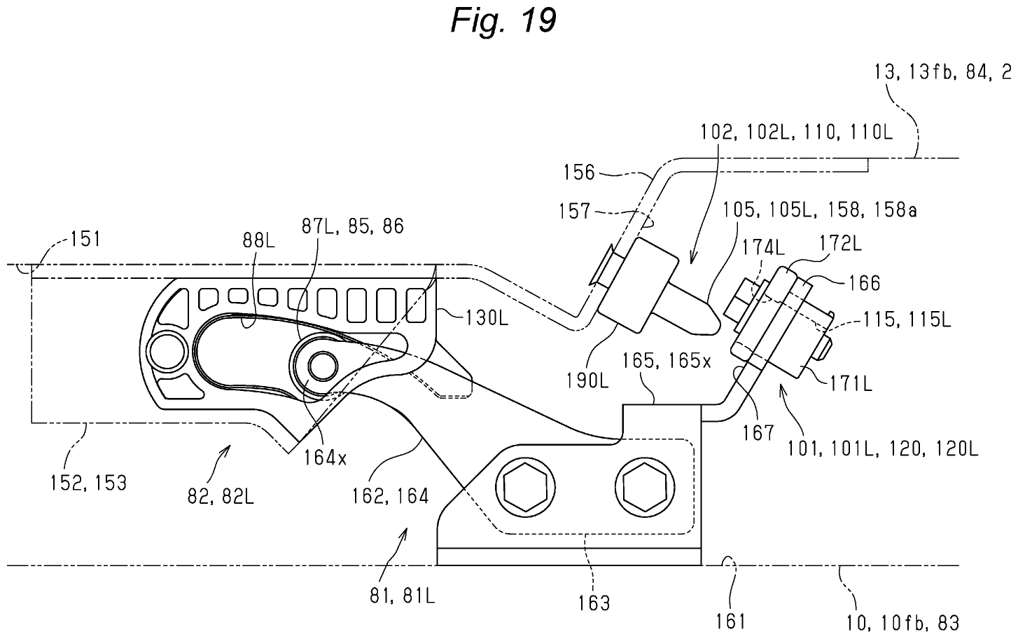

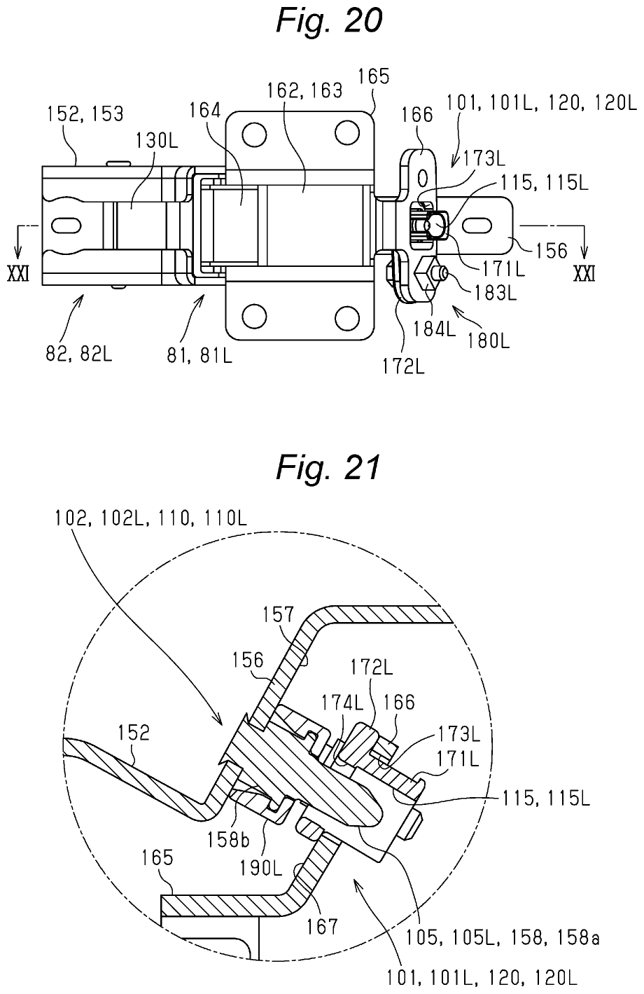

As illustrated in FIGS. 16 to 21, the vehicle door device 30 of the present embodiment includes a guide member 130L that forms a guide groove 88L for the lower vehicle body side engagement portion 82L, similarly to the upper vehicle body side engagement portion 82U. The vehicle door device 30 of the present embodiment includes a bracket 152 that supports the guide member 130L on an installation surface 151 set at the lower edge portion 13fb of the door opening portion 13.

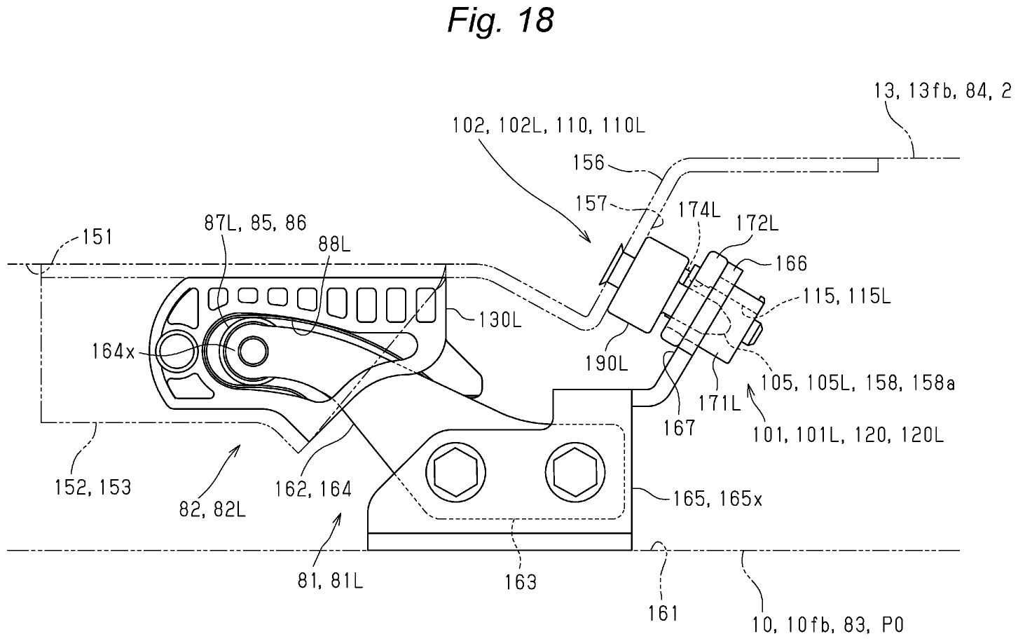

In the vehicle door device 30 of the present embodiment, the bracket 152 has a holder portion 153 having a substantially square tubular outer shape and arranged at an end portion on the vehicle front side (left side in FIG. 18) in a state of being fixed to the installation surface 151. The guide member 130L of the present embodiment is configured to be supported by the bracket 152 in a state of being fitted to the tubular shape of the holder portion 153.

In addition, in the vehicle door device 30 of the present embodiment, the bracket 152 has an extending portion 156 extending from a position where the bracket 152 supports the guide member 130L toward the vehicle rear side (the right side in FIG. 18). Furthermore, the extending portion 156 forms a support surface 157 facing in the extending direction of the guide groove 88L formed by the guide member 130L, that is, the direction in which the closing side end portion 83 of the door 10 and the closing side end portion 84 of the door opening portion 13 come into contact with and separate from each other (lower right side in FIG. 18) based on the opening or closing operation of the door 10. The vehicle door device 30 of the present embodiment includes a shaft-shaped engagement pin 158 supported by the extending portion 156 of the bracket 152 so as to protrude from the support surface 157.

Specifically, in the vehicle door device 30 of the present embodiment, the engagement pin 158 is also provided such that a distal end portion 158a thereof protrudes in a direction in which the closing side end portion 83 of the door 10 and the closing side end portion 84 of the door opening portion 13 come into contact with and separate from each other. The vehicle door device 30 of the present embodiment has a configuration in which the distal end portion 158a of the engagement pin 158 is used as the fitting protrusion 105L of the male fitting member 110L, and the vehicle body side fitting portion 102L is formed therebelow.

As described above, in the vehicle door device 30 of the present embodiment, the lower vehicle body side engagement portion 82L and the lower vehicle body side fitting portion 102L support the guide member 130L and the male fitting member 110L on the installation surface 151 in a mode in which the bracket 152 is shared. Thus, the vehicle door device 30 of the present embodiment has a configuration in which the lower vehicle body side engagement portion 82L and the lower vehicle body side fitting portion 102L are integrated.

On the other hand, similarly to the support member 142 constituting the upper door side engagement portion 81U, the lower door side engagement portion 81L includes a support member 162 that supports the roller 87L, as the guide engagement portion 85, with respect to the installation surface 161 set at the lower end portion 10fb of the door 10. Further, the support member 162 includes a fixing portion 163 with respect to the installation surface 161 and a support arm 164 that supports the roller 87L at a distal end 164x thereof. The vehicle door device 30 of the present embodiment includes a bracket 165 that fixes the fixing portion 163 of the support member 162 to the installation surface 161.

Specifically, in the vehicle door device 30 of the present embodiment, the fixing portion 163 of the support member 162 has a substantially square columnar block shape. In addition, the bracket 165 of the present embodiment has a bent shape 165x with a substantially U-shaped cross section corresponding to the block shape of the fixing portion 163, and is fixed to the installation surface 161. The vehicle door device 30 of the present embodiment is configured such that the fixing portion 163 of the support member 162 is fastened to the bracket 165 in a state where the fixing portion 163 is disposed in the bent shape 165x of the bracket 165.

Note that in the case of the lower door side engagement portion 81L as well, the support arm 164 has a curved elongated shape extending toward the vehicle front side similarly to the support arm 144 constituting the upper door side engagement portion 81U. Thus, the lower door side engagement portion 81L is also configured such that the roller 87L enters the guide groove 88L of the vehicle body side engagement portion 82L based on the closing operation of the door 10 moving to the fully closed position P0 without the support arm 164 interfering with the guide member 130L.

In addition, the bracket 165 of the present embodiment has an extending portion 166 extending from the bent shape 165x toward the vehicle rear side. Further, the extending portion 166 forms a support surface 167 facing in a direction in which the support arm 164 protrudes from the fixing portion 163, that is, the direction in which the closing side end portion 83 of the door 10 and the closing side end portion 84 of the door opening portion 13 come into contact with and separate from each other (upper left side in FIG. 18) based on the opening or closing operation of the door 10. The vehicle door device 30 of the present embodiment is configured such that the lower door side fitting portion 101L is formed by fixing the female fitting member 120L to the extending portion 166 of the support member 162.

That is, the female fitting member 120L of the present embodiment, in a state of being fixed to the extending portion 166 of the bracket 165, has a fitting recess 115L extending in a direction substantially orthogonal to the support surface 167 formed by the extending portion 166. Thus, the vehicle door device 30 of the present embodiment is configured such that the fitting protrusion 105L of the male fitting member 110L constituting the vehicle body side fitting portion 102L is inserted into and removed from the fitting recess 115L of the female fitting member 120L based on the opening or closing operation of the door 10.

As described above, in the vehicle door device 30 of the present embodiment, the lower door side engagement portion 81L and the lower door side fitting portion 101L support the guide member 130L and the female fitting member 120L on the installation surface 161 in a mode in which the bracket 165 is shared. Thus, the vehicle door device 30 of the present embodiment has a configuration in which the lower door side engagement portion 81L and the lower door side fitting portion 101L are integrated.

Furthermore, in the vehicle door device 30 according to the present embodiment, the lower door side engagement portion 81L and the lower vehicle body side engagement portion 82L are engaged in the state where the roller 87L, as the guide engagement portion 85, is disposed in the guide groove 88L as described above. The vehicle door device 30 of the present embodiment is configured such that the fitting protrusion 105L of the male fitting member 110L and the fitting recess 115L of the female fitting member 120L are inserted and removed in a state where the opening or closing operation of the door 10 is guided.

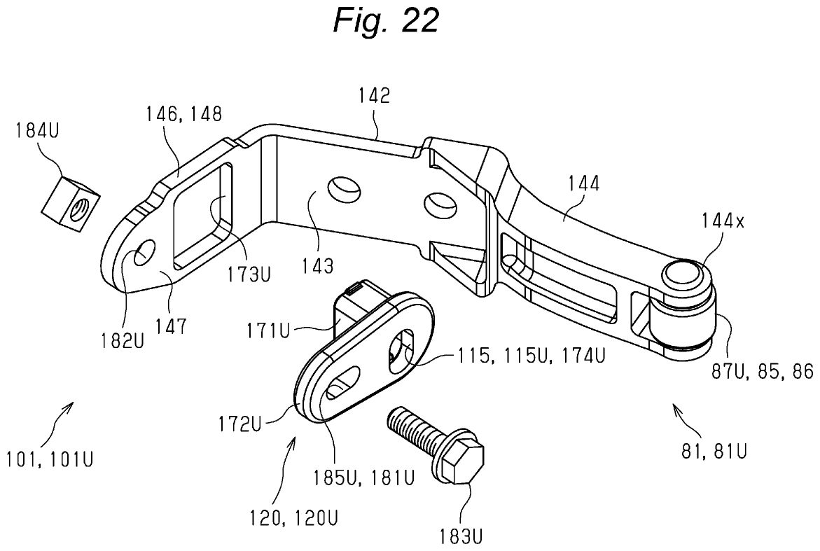

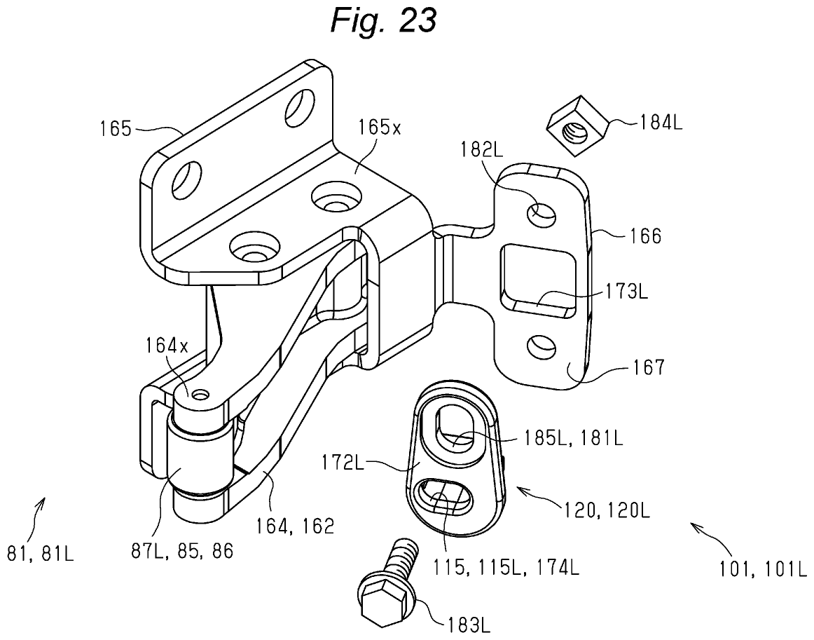

More specifically, as illustrated in FIGS. 15 and 21 to 25, the female fitting members 120U and 120L constituting the door side fitting portions 101U and 101L, have tubular portions 171U and 171L forming the fitting recesses 115U and 115L, respectively. The female fitting members 120U and 120L have flange portions 171U and 171L provided at axial end portions of the tubular portions 172U and 172L, respectively.

The support surfaces 147 and 167 of the brackets 148 and 165 that support the female fitting members 120U and 120L are respectively provided with hole portions 173U and 173L in which the tubular portions 171U and 171L are disposed. Specifically, in the vehicle door device 30 of the present embodiment, the tubular portions 171U and 171L of the female fitting members 120U and 120L have a substantially square tubular outer shape. In addition, each of the hole portions 173U and 173L opened in the support surfaces 147 and 167 of each bracket 148 and 165 has a square hole shape having a larger diameter than the tubular portions 171U and 171L arranged inside thereof. Further, each of the female fitting members 120U and 120L is assembled to each bracket 148 and 165 in a state where the flange portions 172U and 172L thereof come in contact with the support surfaces 147 and 167. In this state, each of the female fitting members 120U and 120L of the present embodiment is configured such that the flange portions 172U and 172L are fastened to the support surfaces 147 and 167 of the corresponding brackets 148 and 165.

Further, in a state where the female fitting members 120U and 120L of the present embodiment are supported by the installation surfaces 131 and 151, the axes of the tubular portions 171U and 171L are substantially orthogonal to the support surfaces 147 and 167 of the fastened brackets 148 and 165. That is, each of the tubular portions 171U and 171L extends in a direction in which the closing side end portion 83 of the door 10 and the closing side end portion 84 of the door opening portion 13 come into contact with and separate from each other based on the opening or closing operation of the door 10. Thus, the female fitting members 120U and 120L of the present embodiment are configured such that the insides of the tubular portions 171U and 171L function as the fitting recesses 115U and 115L, respectively.

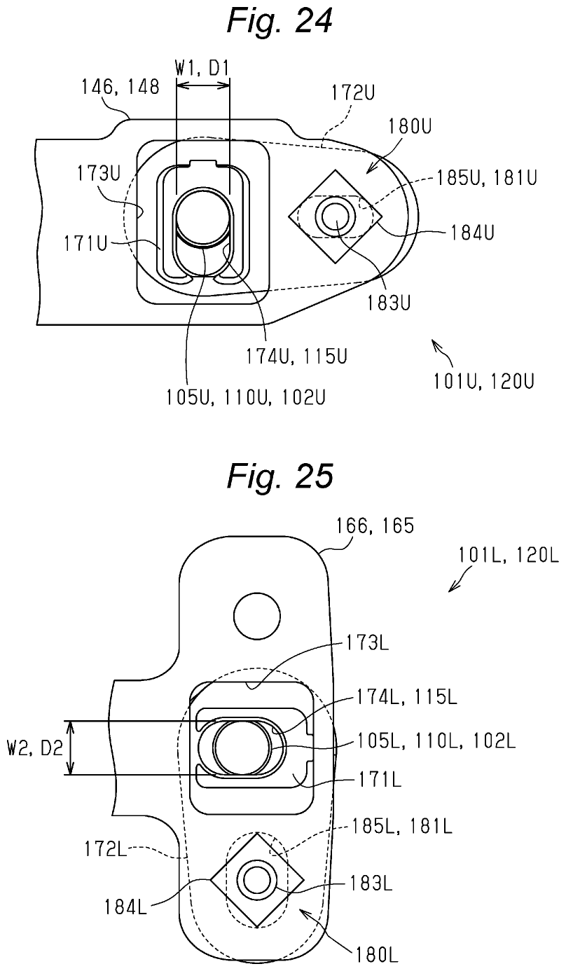

More specifically, as illustrated in FIG. 24, in the vehicle door device 30 of the present embodiment, an inlet shape of the tubular portion 171U of the female fitting member 120U constituting the upper door side fitting portion 101U is a long hole 174U extending in the vertical direction of the vehicle 1. Further, in the long hole 174U, a width W1 substantially equal to a diameter D1 of the fitting protrusion 105U of the male fitting member 110U constituting the upper vehicle body side fitting portion 102U is set (D1≈W1). Thus, the upper door side fitting portion 101U and the upper vehicle body side fitting portion 102U are configured such that the relative displacement in the horizontal direction in a state where the fitting protrusion 105U of the male fitting member 110U is inserted into the fitting recess 115U of the female fitting member 120U is restricted.

Specifically, in the vehicle door device 30 of the present embodiment, when the door 10 is at the fully closed position P0, the displacement of the door 10 in the vehicle width direction is restricted by the fitting of the upper door side fitting portion 101U and the upper vehicle body side fitting portion 102U. Furthermore, also at the engagement positions of the door side engagement portion 81 and the vehicle body side engagement portion 82, the displacement of the door 10 in the vehicle width direction is restricted by the engagement between the side wall portions 88a and 88b of the guide groove 88 facing each other in the vehicle width direction and the roller 87 as the guide engagement portion 85 and the shaft-shaped engagement portion 86. Thus, the vehicle door device of the present embodiment is configured to ensure a high degree of support rigidity of the door at the fully closed position P0.

On the other hand, as illustrated in FIG. 25, in the female fitting member 120L constituting the lower door side fitting portion 101L, the inlet shape of the tubular portion 171L is a long hole 174L extending in the horizontal direction. Further, in the long hole 174L, a width W2 substantially equal to a diameter D2 of the fitting protrusion 105L of the male fitting member 110L constituting the lower vehicle body side fitting portion 102L is set (D2≈W2). Thus, the lower door side fitting portion 101L and the lower vehicle body side fitting portion 102L are configured such that the relative displacement in the vertical direction in a state where the fitting protrusion 105U of the male fitting member 110U is inserted into the fitting recess 115L of the female fitting member 120L is restricted.

Specifically, in the vehicle door device 30 of the present embodiment, when the door 10 is at the fully closed position P0, the displacement of the door 10 in the vertical direction is restricted by the fitting of the lower door side fitting portion 101L and the lower vehicle body side fitting portion 102L. In addition, at the engagement position of the door side engagement portion 81 and the vehicle body side engagement portion 82, the relative displacement in the vertical direction of the roller 87 disposed between the side wall portions 88a and 88b of the guide groove 88 facing each other in the vehicle width direction is suppressed. Thus, the vehicle door device 30 of the present embodiment has a configuration in which it is difficult for the roller 87 disposed in the guide groove 88 to become removed due to the vertical displacement.

As described above, in the vehicle door device 30 of the present embodiment, in the upper female fitting member 120U and the upper male fitting member 110U, and in the lower female fitting member 120L and the lower male fitting member 110L, a restriction direction of the relative displacement due to the fitting is set in different directions. Thus, the door 10 is more stably supported at the fully closed position P0, and the ease of assembly is ensured.

In addition, the vehicle door device 30 of the present embodiment includes a support position adjustment mechanism 180U that can adjust the support position of the female fitting member 120U constituting the upper door side fitting portion 101U by the bracket 148.

Specifically, as illustrated in FIGS. 15, 22, and 24, in the vehicle door device 30 of the present embodiment, the female fitting member 120U has a through hole 181U provided in the flange portion 172U. In addition, the extending portion 146 of the support member 142 constituting the bracket 148 of the female fitting member 120U is also provided with a through hole 182U opened to the support surface 147. Further, the vehicle door device 30 of the present embodiment includes a bolt 183U inserted into the through holes 181U and 182U, and a nut 184U screwed on to the bolt 183U. The female fitting member 120U of the present embodiment is configured to be fastened to the support surface 147 of the bracket 148 based on the fastening force of the bolt 183U and the nut 184U.

In addition, in the vehicle door device 30 of the present embodiment, the through hole 181U provided in the flange portion 172U of the female fitting member 120U has a configuration as a long hole 185U extending in the horizontal direction in a state where the female fitting member 120U is fastened to the bracket 148. That is, in the female fitting member 120U of the present embodiment, the assembly position of the flange portion 172U with respect to the support surface 147 can be adjusted in a range in which the long hole 185U through which the bolt 183U is inserted extends. Furthermore, the position of the tubular portion 171U of the female fitting member 120U arranged in the hole portion 173U of the bracket 148 can also be adjusted in the hole portion 173U having a larger diameter than the tubular portion 171U. The vehicle door device 30 of the present embodiment is configured such that the support position adjustment mechanism 180U of the female fitting member 120U is thus formed.

That is, in the vehicle door device 30 of the present embodiment, the support position of the female fitting member 120U can be adjusted in the horizontal direction by using a function of the support position adjustment mechanism 180U. Thus, the upper door side fitting portion 101U and the upper vehicle body side fitting portion 102U, which restrict the relative displacement in the horizontal direction by fitting to each other, are configured to ensure smooth insertion and removal of the fitting protrusion 105U with respect to the fitting recess 115U.

In addition, the vehicle door device 30 of the present embodiment includes a support position adjustment mechanism 180L that can adjust the support position of the female fitting member 120L constituting the lower door side fitting portion 101L by the bracket 165.

Specifically, as illustrated in FIGS. 21, 23, and 25, in the vehicle door device 30 of the present embodiment, the female fitting member 120L has a through hole 181L provided in the flange portion 172L. Note that the extending portion 166 of the support member 162 constituting the bracket 165 of the female fitting member 120L is also provided with a through hole 182L opened to the support surface 167. Further, the vehicle door device 30 of the present embodiment includes a bolt 183L inserted into the through holes 181L and 182L, and a nut 184L screwed on to the bolt 183L. The female fitting member 120L of the present embodiment is configured to be fastened to the support surface 167 of the bracket 165 based on the fastening force of the bolt 183L and the nut 184L.

In addition, in the vehicle door device 30 of the present embodiment, the through hole 181L provided in the flange portion 172L of the female fitting member 120L has a configuration as a long hole 185L extending in the vertical direction in a state where the female fitting member 120L is fastened to the bracket 165. That is, in the female fitting member 120L of the present embodiment, the assembly position of the flange portion 172L with respect to the support surface 167 can be adjusted in a range in which the long hole 185L through which the bolt 183L is inserted extends. Furthermore, the position of the tubular portion 171L of the female fitting member 120L arranged in the hole portion 173L of the bracket 165 can also be adjusted in the hole portion 173L having a larger diameter than the tubular portion 171L. The vehicle door device 30 of the present embodiment is configured such that the support position adjustment mechanism 180L of the female fitting member 120L is thus formed.

That is, in the vehicle door device 30 of the present embodiment, the support position of the female fitting member 120L can be adjusted in the vertical direction by using a function of the support position adjustment mechanism 180L. Thus, the lower door side fitting portion 101L and the lower vehicle body side fitting portion 102L, which restrict the relative displacement in the vertical direction by fitting to each other, are configured to ensure smooth insertion and removal of the fitting protrusion 105L with respect to the fitting recess 115L.

In addition, as illustrated in FIGS. 12 and 15, the vehicle door device 30 of the present embodiment includes a buffer member 190U interposed between the upper door side fitting portion 101U and the upper vehicle body side fitting portion 102U in a state where the female fitting member 120U and the male fitting member 110U are fitted to each other. In the vehicle door device 30 of the present embodiment, the buffer member 190U is formed using an elastic material such as rubber. In addition, the buffer member 190U has a flat substantially columnar outer shape. Further, the buffer member 190U of the present embodiment is fitted to the proximal end portion 158b of the engagement pin 158 constituting the fitting protrusion portion 105U of the male fitting member 110U (see FIG. 10). Thus, configuration is such that, in a state where the fitting protrusion 105U of the male fitting member 110U is inserted into the fitting recess 115U of the female fitting member 120U, the buffer member 190U is interposed between the bracket 148 of the door side fitting portion 101U and the bracket 132 of the vehicle body side fitting portion 102U.

In addition, as illustrated in FIGS. 18 and 21, the vehicle door device 30 of the present embodiment similarly includes a buffer member 190L interposed between the lower door side fitting portion 101L and the lower vehicle body side fitting portion 102L in a state where the female fitting member 120L and the male fitting member 110L are fitted to each other. The buffer member 190L is also formed using an elastic material such as rubber, similarly to the upper buffer member 190U. Furthermore, the buffer member 190L also has a flat substantially columnar outer shape, and is fitted to the proximal end portion 158b of the engagement pin 158 constituting the fitting protrusion 105L of the male fitting member 110L (see FIG. 16). Thus, configuration is such that, in a state where the fitting protrusion 105L of the male fitting member 110L is inserted into the fitting recess 115L of the female fitting member 120L, the buffer member 190L is interposed between the bracket 165 of the door side fitting portion 101L and the bracket 152 of the vehicle body side fitting portion 102L.

That is, when the female fitting members 120U and 120L and the male fitting members 110U and 110L are fitted to each other, the buffer members 190U and 190L interposed between the door side fitting portions 101U and 101L and the vehicle body side fitting portions 102U and 102L alleviate impact. Thus, the vehicle door device 30 of the present embodiment is configured to suppress generation of sound and vibration to ensure a high degree of quietness when the door 10 moves to the fully closed position P0, and to improve durability and reliability thereof.

(Operation)

Next, the operation of the present embodiment will be described.

In the vehicle door device 30 of the present embodiment, the fitting protrusions 105U and 105L of the male fitting members 110U and 110L are inserted into the fitting recesses 115U and 115L of the female fitting members 120U and 120L based on the closing operation of the door 10 moving to the fully closed position P0. In addition, the fitting protrusions 105U and 105L of the male fitting members 110U and 110L are removed from the fitting recesses 115U and 115L of the female fitting members 120U and 120L based on the opening operation of the door 10 moved from the fully closed position P0. When the door 10 is at the fully closed position P0, the relative displacement between the female fitting members 120U and 120L and the male fitting members 110U and 110L is restricted in a direction intersecting the insertion or removal direction of the fitting protrusions 105U and 105L with respect to the fitting recesses 115U and 115L.

As described above, in the vehicle door device 30 of the present embodiment, the door constituting the rear door 5R of the vehicle 1 is fitted to the door side fitting portions 101U and 101L and the vehicle body side fitting portions 102U and 102L, so that the front end portion 10f is supported by the closing side end portion 84 of the door opening portion 13. Furthermore, at this time, the rear end portion 10r of the door 10 is supported by the rear edge portion 3r of the door opening portion 3, that is, the opening side end portion of the door opening portion 13 based on the engagement force between the locking device 92r and the striker 94 as described above. Thus, the vehicle door device 30 of the present embodiment can stably support the front end portion 10f and the rear end portion 10r of the door 10 in the fully closed state in a so-called “both-side holding state”.

Next, the effect of the present embodiment will be described.

(1) A vehicle door device includes: first and second link arms each having a first pivot connection point with respect to a vehicle body and a second pivot connection point with respect to a door of a vehicle; a door side fitting portion provided at a closing side end portion of the door that opens and closes a door opening portion of the vehicle based on an operation of a link mechanism formed by the first and second link arms; and a vehicle body side fitting portion provided at a closing side end portion of the door opening portion with and from which the closing side end portion of the door comes in contact and separates based on an opening or closing operation of the door; wherein one side of the door side fitting portion and the vehicle body side fitting portion includes a male fitting member having a fitting protrusion protruding in a direction in which the closing side end portion of the door and the closing side end portion of the door opening portion come in contact with and separate from each other; the other side of the door side fitting portion and the vehicle body side fitting portion includes a female fitting member having a fitting recess into and from which the fitting protrusion is inserted and removed based on an opening or closing operation of the door; and when the door is at a fully closed position, the male fitting member and the female fitting member are fitted to each other, so that relative displacement in a direction intersecting an insertion or removal direction of the fitting protrusion with respect to the fitting recess can be restricted.

In other words, the vehicle door device 30 includes the first and second link arms 21 and 22 having the first pivot connection point X1 with respect to the vehicle body 2 and the second pivot connection point X2 with respect to the door 10 of the vehicle 1. In addition, the vehicle door device includes the door side fitting portion 101 provided at the closing side end portion 83 of the door that opens and closes the door opening portion 13 of the vehicle 1 based on the operation of the link mechanism 25 formed by the first and second link arms 21 and 22. Further, the vehicle door device 30 includes the vehicle body side fitting portion 102 provided at the closing side end portion 84 of the door opening portion 13 where the closing side end portion 83 of the door 10 comes into contact with and separates from based on the opening or closing operation of the door 10. The vehicle body side fitting portion 102 includes the male fitting member 110 having the fitting protrusion 105 protruding in a direction in which the closing side end portion 83 of the door 10 and the closing side end portion 84 of the door opening portion 13 come into contact with and separate from each other. The door side fitting portion 101 includes the female fitting member 120 having a fitting recess 115 into which the fitting protrusion 105 is inserted and removed based on the opening or closing operation of the door 10. The vehicle door device 30 is configured so that when the door 10 is at the fully closed position P0 it is possible to restrict the relative displacement in the direction intersecting the insertion or removal direction of the fitting protrusion 105 with respect to the fitting recess 115 by fitting the male fitting member 110 and the female fitting member 120.

With the above configuration, when the door 10 is at the fully closed position P0, the door can be stably supported. Further, by restricting the relative displacement by the fitting between the male fitting member 110 and the female fitting member 120, looseness may be suppressed. As a result, for example, it is possible to suppress generation of sound and vibration during traveling of the vehicle.

Furthermore, by ensuring a high degree of support rigidity in the fully closed state, loads on the first and second link arms 21 and 22 forming the link mechanism 25 are reduced. As a result, it is possible to reduce the size and weight.

(2) The vehicle door device according to (1) includes: a door side engagement portion provided at a closing side end portion of the door; and a vehicle body side engagement portion provided at a closing side end portion of the door opening portion, wherein one side of the door side engagement portion and the vehicle body side engagement portion includes a guide engagement portion; the other side of the door side engagement portion and the vehicle body side engagement portion includes a guide groove having a pair of side wall portions facing each other and extending in an opening or closing operation direction of the door; and in a vicinity of a fully closed position of the door where the door side engagement portion and the vehicle body side engagement portion are engaged with each other, in a state where the guide engagement portion is disposed in the guide groove to guide the opening or closing operation of the door, the fitting protrusion of the male fitting member and the fitting recess of the female fitting member are inserted and removed.

In other words, the vehicle door device 30 includes the door side engagement portion 81 provided at the closing side end portion 83 of the door 10, and the vehicle body side engagement portion 82 provided at the closing side end portion 84 of the door opening portion 13. The door side engagement portion 81 includes the guide engagement portion 85, and the vehicle body side engagement portion 82 includes the guide groove 88 having the pair of side wall portions 88a and 88b facing each other and extending in the opening or closing operation direction of the door 10. Further, in the vicinity of the fully closed position P0 of the door 10 where the door side engagement portion 81 and the vehicle body side engagement portion 82 are engaged with each other, the opening or closing operation of the door 10 is guided in a state where the guide engagement portion 85 is disposed in the guide groove 88. In this manner, the fitting protrusion 105 of the male fitting member 110 and the fitting recess 115 of the female fitting member 120 are inserted and removed in a state where the opening or closing operation of the door 10 is guided by the engagement between the door side engagement portion 81 and the vehicle body side engagement portion 82.

With the above configuration, when the guide engagement portion 85 moves in the guide groove 88, the door 10 can be smoothly closed to the fully closed position P0 and opened from the fully closed position P0. Furthermore, the door side fitting portion 101 and the vehicle body side fitting portion 102 can be relatively moved along the insertion or removal direction of the fitting protrusion 105 of the male fitting member 110 and the fitting recess 115 of the female fitting member 120. Thus, the fitting protrusion 105 and the fitting recess 115 can be smoothly and reliably inserted and removed.

In addition, by arranging the guide engagement portion 85 in the guide groove 88, the relative displacement in a direction in which the side wall portions 88a and 88b face each other is restricted. As a result, the door 10 can be stably supported even in the vicinity of the fully closed position P0 where the distance between the first and second link arms 21 and 22 is short and the first and second link arms 21 and 22 are likely to be linearly arranged.

Further, when the door 10 is at the fully closed position P0, the door 10 and the vehicle body 2 are connected not only at the fitting position of the door side fitting portion 101 and the vehicle body side fitting portion 102, but also at the engagement position of the door side engagement portion 81 and the vehicle body side engagement portion 82. Thus, a higher degree of support rigidity may be ensured.

That is, at the fitting position of the door side fitting portion 101 and the vehicle body side fitting portion 102, relative rotation around the fitting protrusion 105 inserted into the fitting recess 115 can be restricted. In addition, at the engagement position of the door side engagement portion 81 and the vehicle body side engagement portion 82, looseness of the guide engagement portion 85 disposed in the guide groove 88 can be suppressed. As a result, for example, it is possible to suppress generation of sound and vibration during traveling of the vehicle. In addition, durability can be improved.

Furthermore, for example, even when an impact load is applied to the door 10 at the time of a side collision or the like, it is difficult for the guide engagement portion 85 disposed in the guide groove 88 to become removed. Thus, the fully closed state of the door 10 can be maintained, and a high degree of safety can be ensured.

(3) The vehicle door device according to (2), wherein the door side fitting portion and the door side engagement portion are integrally formed, and the vehicle body side fitting portion and the vehicle body side engagement portion are integrally formed.

In other words, in the vehicle door device 30, the door side fitting portion 101 and the door side engagement portion 81 are integrally formed, and the vehicle body side fitting portion 102 and the vehicle body side engagement portion 82 are integrally formed.

With the above configuration, the ease of assembly can be improved. Furthermore, the positional relationship between the fitting position of the door side fitting portion 101 and the vehicle body side fitting portion 102 and the engagement position of the door side engagement portion 81 and the vehicle body side engagement portion 82 can be set in advance. Thus, the door 10 can be more stably supported at the fully closed position P0.

(4) The vehicle door device according to (2) wherein the guide engagement portion is configured as a roller disposed between the pair of side wall portions in a state of being rotatably supported around a support shaft.

In other words, the guide engagement portion 85 has a configuration as the roller 87 arranged between the side wall portions 88a and 88b of the guide groove 88 in a state of being rotatably supported around the support shaft 87x.

With the above configuration, the guide engagement portion 85 can smoothly slide in the guide groove 88 by the rotation of the roller 87. As a result, it is possible to more smoothly guide the opening or closing operation of the door 10 in the vicinity of the fully closed position P0. Furthermore, by enhancing the support rigidity at the fully closed position P0 by the fitting of the door side fitting portion 101 and the vehicle body side fitting portion 102, it is possible, for example, to suppress wear and deformation caused by the roller 87 coming into contact with the side wall portions 88a and 88b of the guide groove 88 due to vibration during traveling of the vehicle. Thus, the opening or closing operation of the door 10 in the vicinity of the fully closed position P0 can be stably guided while securing smooth sliding of the roller 87 in the guide groove 88 and smooth disengagement with respect to the guide groove 88. Therefore, by applying to such a configuration, a more remarkable effect can be obtained.

(5) The vehicle door device according to (3) includes the male fitting member and the female fitting member configured to be able to restrict the relative displacement in the horizontal direction intersecting the insertion or removal direction.

In other words, the vehicle door device 30 includes the upper door side fitting portion 101U provided at the upper end portion 10fa of the door 10 and the upper vehicle body side fitting portion 102U provided at the upper edge portion 13fa of the door opening portion 13. The door side fitting portion 101U and the vehicle body side fitting portion 102U include the female fitting member 120U and the male fitting member 110U configured to be able to restrict the relative displacement in the horizontal direction intersecting the insertion or removal direction of the fitting protrusion 105U with respect to the fitting recess 115U by the fitting.

With the above configuration, for example, the displacement of the door 10 in the vehicle width direction can be restricted by the fitting of the door side fitting portion 101U and the vehicle body side fitting portion 102U. Thus, a high degree of support rigidity of the door 10 at the fully closed position P0 can be secured.

In particular, a horizontal support load due to falling of the door 10 acts on the upper end portion 10fa of the door 10 of the vehicle 1. Therefore, a more remarkable effect can be obtained by restricting the displacement of the door 10 in the horizontal direction in the upper door side fitting portion 101U and the upper vehicle body side fitting portion 102U.

(6) The vehicle door device according to (4) includes the male fitting member and the female fitting member configured to be able to restrict the relative displacement in the vertical direction intersecting the insertion or removal direction.

In other words, the vehicle door device 30 includes a lower door side fitting portion 101L provided at the lower end portion 10fb of the door 10 and a lower vehicle body side fitting portion 102L provided at the lower edge portion 13fb of the door opening portion 13. The door side fitting portion 101L and the vehicle body side fitting portion 102L include the female fitting member 120L and the male fitting member 110L configured to be able to restrict the relative displacement in the vertical direction intersecting the insertion or removal direction of the fitting protrusion 105L with respect to the fitting recess 115L by the fitting.

With the above configuration, the displacement of the door 10 in the vertical direction can be restricted by the fitting of the door side fitting portion 101L and the vehicle body side fitting portion 102L. Thus, a high degree of support rigidity of the door 10 at the fully closed position P0 can be secured.

In particular, in the door 10 of the vehicle 1, the displacement component in the vertical direction tends to be large on the lower end portion 10fb side. Therefore, a more remarkable effect can be obtained by restricting the displacement of the door 10 in the vertical direction in the lower door side fitting portion 101L and the lower vehicle body side fitting portion 102L.

(7) The vehicle door device according to (3) includes the male fitting member and the female fitting member configured to be able to restrict the relative displacement in the vertical direction intersecting the insertion or removal direction.

As described above, in the vehicle door device 30, in the upper female fitting member 120U and the upper male fitting member 110U, and in the lower female fitting member 120L and the lower male fitting member 110L, a restriction direction of the relative displacement due to the fitting is set in different directions. Thus, the door 10 can be more stably supported at the fully closed position P0. In addition, assembly can be improved.

(8) The vehicle door device according to (4) includes the male fitting member and the female fitting member configured to be able to restrict the relative displacement in the vertical direction intersecting the insertion or removal direction.

In other words, the door side fitting portions 101U and 101L include the brackets 148 and 165 that support the female fitting members 120U and 120L as the fitting members on the installation surfaces 141 and 161. The door side fitting portions 101U and 101L include support position adjustment mechanisms 180U and 180L that can adjust the support positions of the female fitting members 120U and 120L by the brackets 148 and 165.

With the above configuration, when the female fitting members 120U and 120L constituting the door side fitting portions 101U and 101L are assembled, the support positions thereof can be easily adjusted. As a result, it is possible to ensure smooth insertion and removal of the fitting recesses 115U and 115L of the female fitting members 120U and 120L and the fitting protrusions 105U and 105L of the male fitting members 110U and 110L.

(9) The vehicle door device according to (1) includes a plurality of sets of the male fitting member and the female fitting member having different directions in which the relative displacement is restricted.

In other words, the vehicle door device 30 does not include the locking device 92 that restrains the closing side end portion 83 of the door 10 to the closing side end portion 84 of the door opening portion 13.

With the above configuration, since the restraint force by the locking device 92 cannot be used, the support rigidity when the door 10 is at the fully closed position P0 tends to be low. Therefore, by applying such a configuration, a more remarkable effect can be obtained. For example, even when an impact load is applied to the door 10 at the time of side collision or the like, a force capable of maintaining the fully closed state of the door 10 increases. Thus, a high degree of safety can be ensured.

(10) The vehicle door device according to (1) wherein at least one of the door side fitting portion and the vehicle body side fitting portion includes a bracket that supports one of the male fitting member and the female fitting member on an installation surface, and includes a support position adjustment mechanism that enables adjustment of a support position of the fitting member by the bracket.

In other words, the vehicle door device 30 includes the buffer members 190U and 190L interposed between the door side fitting portions 101U and 101L and the vehicle body side fitting portions 102U and 102L in a state where the female fitting members 120U and 120L and the male fitting members 110U and 110L are fitted to each other.

With the above configuration, it is possible to alleviate the impact when the female fitting members 120U and 120L and the male fitting members 110U and 110L are fitted to each other. As a result, at the time of the full-closing operation of the door 10, generation of sound and vibration can be suppressed to ensure a high degree of quietness. In addition, the durability and reliability thereof can be improved.

(11) The vehicle door device according to (1) does not include a locking device that restrains a closing side end portion of the door to a closing side end portion of the door opening portion.

In other words, the second link arm 22 constituting the link mechanism 25 is provided with the variable connection length mechanism 50 capable of changing the connection length L between the first and second pivot connection points X1 and X2.

With the above configuration, the degree of freedom of the opening or closing operation can be increased based on the operation of the variable connection length mechanism 50. However, as the degree of freedom of the opening or closing operation increases, the swing of the door 10 also tends to increase. Therefore, by applying such a configuration, a more remarkable effect can be obtained.

(12) The vehicle door device according to (1) includes a buffer member interposed between the door side fitting portion and the vehicle body side fitting portion in a state where the male fitting member and the female fitting member are fitted to each other.

In other words, the vehicle door device 30 includes the actuator 90R that applies a driving force to the link mechanism 25 to open and close the door 10. As a result, convenience can be improved. Further, by applying such a configuration, it is possible to ensure a high quality feel by improving the support rigidity.

(13) The vehicle door device according to (1) wherein at least one of the first and second link arms is provided with a variable connection length mechanism capable of changing a connection length between the first and second pivot connection points.

(14) The vehicle door device according to (1) includes an actuator that applies a driving force to the link mechanism to open and close the door.

According to the present disclosure, the door can be stably supported at the fully closed position.

Note that the above embodiments can be modified as follows. The above embodiments and the following modified examples can be implemented in combination with each other to the extent that they are not technically inconsistent.

In the above embodiments, the door side fitting portion 101 has the female fitting member 120, and the vehicle body side fitting portion 102 has the male fitting member 110. However, the configuration is not limited thereto, and configuration may be such that the vehicle body side fitting portion 102 has the female fitting member 120, and the door side fitting portion 101 has the male fitting member 110.

In the above embodiments, as the door side fitting portion 101, the upper door side fitting portion 101U and the lower door side fitting portion 101L are provided in the upper end portion 10fa and the lower end portion 10fb at the front end portion 10f that is the closing side end portion 83 of the door 10. In addition, as the vehicle body side fitting portion 102, an upper vehicle body side fitting portion 102U and a lower vehicle body side fitting portion 102L are provided in the upper edge portion 13fa and the lower edge portion 13fb at the position that is the closing side end portion 84 of the door opening portion 13. Further, the upper door side fitting portion 101U and the upper vehicle body side fitting portion 102U are configured to be able to restrict the relative displacement in the horizontal direction by the fitting of the female fitting member 120U and the male fitting member 110U. The lower door side fitting portion 101L and the lower vehicle body side fitting portion 102L are configured to be able to restrict the relative displacement in the vertical direction by the fitting of the female fitting member 120L and the male fitting member 110L.

However, the configuration is not limited thereto, and a configuration may be such that the upper door side fitting portion 101U and the upper vehicle body side fitting portion 102U restrict the relative displacement in the vertical direction, and the lower door side fitting portion 101L and the lower vehicle body side fitting portion 102L restrict the relative displacement in the horizontal direction. The upper door side fitting portion 101U and the upper vehicle body side fitting portion 102U, and the lower door side fitting portion 101L and the lower vehicle body side fitting portion 102L may also be configured to restrict the relative displacement in the vertical direction, or may be configured to restrict the relative displacement in the horizontal direction.

In addition, the restriction direction of the relative displacement due to the fitting between the female fitting member 120 and the male fitting member 110 may be arbitrarily changed. For example, configuration may be such that relative displacement in an oblique direction that is an intermediate direction between the vertical direction and the horizontal direction is restricted. The relative displacement may be restricted in all directions intersecting the insertion or removal direction of the fitting protrusion 105 with respect to the fitting recess 115.

The arrangement of the door side fitting portion 101 and the upper vehicle body side fitting portion 102 may be arbitrarily changed. For example, when there is a structural body extending in the vertical direction, such as a “B pillar”, at a position that becomes the closing side end portion 84 of the door opening portion 13, the vehicle body side fitting portion 102 may be provided at that position. The number of sets of the door side fitting portion 101 and the upper vehicle body side fitting portion 102 fitted to each other may also be arbitrarily changed. There may be one, or three or more. When the number of sets is three or more, the number of sets of the male fitting member 110 and the female fitting member 120 having different directions of restricting the relative displacement may be three or more.

In the above embodiments, the fitting protrusions 105U and 105L of the male fitting members 110U and 110L are formed by the distal end portions 138a and 158a of the shaft-shaped engagement pins 138 and 158. The insides of the tubular portions 171U and 171L that constitute the female fitting members 120U and 120L are used as the fitting recesses 115U and 115L. However, the configuration is not limited thereto, and the fitting shapes of the fitting protrusion 105 and the fitting recess 115 may be arbitrarily changed. For example, the fitting protrusion 105 may not have a shaft-like pin shape. The shape of the protrusion is arbitrary. The fitting recess 115 may also not have an elongated hole shape. For example, the fitting recess 115 may have a circular hole shape. The shape of the hole portion is arbitrary. That is, when the door 10 is at the fully closed position P0, the male fitting member 110 and the female fitting member 120 may be fitted to each other so as to be able to restrict the relative displacement in the direction intersecting the insertion or removal direction of the fitting protrusion 105 with respect to the fitting recess 115.

In the above embodiments, the door side engagement portion 81 has the guide engagement portion 85 configured as the shaft-shaped engagement portion 86 and the roller 87, and the vehicle body side engagement portion 82 has the guide groove 88. However, the configuration is not limited thereto, and the door side engagement portion 81 may have the guide groove 88, and the vehicle body side engagement portion 82 may have the guide engagement portion 85.

The shapes of the guide engagement portion 85 and the guide groove 88 may be arbitrarily changed. For example, the shapes do not necessarily have to be a shaft shape. It is not necessary to have a configuration as a rotating body such as the roller 87. The groove shape of the guide groove 88 may also be arbitrarily changed. That is, configuration may be such that in the vicinity of the fully closed position P0 where the door side engagement portion 81 is engaged with the vehicle body side engagement portion 82, the opening or closing operation of the door 10 may be guided in a state where the guide engagement portion 85 is arranged in the guide groove 88.

However, from the viewpoint of restricting the displacement of the door 10 in the vehicle width direction and enhancing the support rigidity thereof, the guide engagement portion 85 has a configuration as the shaft-shaped engagement portion 86 extending in the vertical direction of the vehicle 1. It is preferable to adopt a configuration in which the guide groove 88 has the pair of side wall portions 88a and 88b facing each other in the vehicle width direction, and extends in the opening or closing operation direction of the door 10.

In the above embodiments, as the door side engagement portion 81, an upper door side engagement portion 81U and a lower door side engagement portion 81L provided in the upper end portion 10fa and the lower end portion 10fb at the front end portion 10f to be the closing side end portion 83 of the door 10. In addition, as the vehicle body side engagement portion 82, the upper vehicle body side engagement portion 82U and the lower vehicle body side engagement portion 82L are provided at the upper edge portion 13fa and the lower edge portion 13fb in the position that is the closing side end portion 84 of the door opening portion 13. However, the configuration is not limited thereto, and the arrangement of the door side engagement portion 81 and the vehicle body side engagement portion 82 may be arbitrarily changed. For example, when there is a structural body extending in the vertical direction, such as a “B pillar”, at a position that becomes the closing side end portion 84 of the door opening portion 13, the vehicle body side engagement portion 82 may be provided at that position. The number of sets of the door side engagement portion 81 and the vehicle body side engagement portion 82 that engage with each other may also be arbitrarily changed. There may be one, or three or more.

In the above embodiments, the door side fitting portion 101 and the door side engagement portion 81 are integrally formed, and the vehicle body side fitting portion 102 and the vehicle body side engagement portion 82 are integrally formed. However, the configuration is not limited thereto, and the door side fitting portion 101 and the door side engagement portion 81 may be formed separately, and the vehicle body side fitting portion 102 and the vehicle body side engagement portion 82 may be formed separately.

In the above embodiments, the female fitting members 120 and 120L are fixed to the brackets 148 and 165 based on the fastening force of the bolts 183U and 183L inserted into the through holes 181U and 181L of the female fitting members 120U and 120L. By configuring the through holes 181U and 181L as the long holes 185U and 185L, the support position adjustment mechanisms 180U and 180L of the female fitting members 120U and 120L by the brackets 148 and 165 are formed. However, the configuration is not limited thereto, and the configurations of these support position adjustment mechanisms 180U and 180L may be arbitrarily changed. However, from the viewpoint of facilitating the position adjustment and securing smooth insertion and removal of the fitting recesses 115U and 115L and the fitting protrusion 105U, it is preferable to set the adjustment direction of the support position in consideration of the restriction direction of the relative displacement due to the fitting.

The fitting member to be subjected to the support position adjustment may be the male fitting member 110. For example, regarding the door side fitting portions 101U and 101L, the support positions of the male fitting members 110U and 110L by the brackets 148 and 165 may be adjustable.

In the above embodiments, the buffer members 190U and 190L are provided in the vehicle body side fitting portions 102U and 102L; however, configuration may be such that the buffer members 190U and 190L are provided in the door side fitting portions 101U and 101L. The shape and material may also be arbitrarily changed.

In the above embodiments, the variable connection length mechanism 50 is provided in the second link arm 22. However, the configuration is not limited thereto, and a configuration may be employed in which the variable connection length mechanism 50 is provided in the first link arm 21. A configuration may also be employed in which the variable connection length mechanism 50 is provided in both the first and second link arms 21 and 22.

In the above embodiments, the variable connection length mechanism 50 has a configuration as the joint link mechanism 60 that rotatably connects the vehicle body side link 51 having the first pivot connection point X1 and the door side link 52 having the second pivot connection point X2. However, the configuration is not limited to this, and the configuration of the variable connection length mechanism 50 may be arbitrarily changed by using a linear expansion/contraction link mechanism or the like. A configuration may be employed in which such a variable connection length mechanism 50 is not provided in either the first link arm 21 or the second link arm 22.

In the above embodiments, a configuration is employed in which the door 10 constituting the rear door 5R of the vehicle 1 performs the opening operation toward the vehicle rear side; however, a configuration may also be employed in which, for example, the door 10 performs the opening operation toward the vehicle front side such as in the case of the front door 5F. The configuration may be applied to a manual configuration without a drive source such as the actuator 90R.

Next, a technical idea that can be grasped from the above embodiments and modifications will be described.

(a) The vehicle door device, wherein the guide engagement portion has a configuration as a shaft-shaped engagement portion extending in the vertical direction of the vehicle, and the guide groove has the pair of side wall portions facing each other in the vehicle width direction, and extends in the opening or closing operation direction of the door. This makes it possible to effectively restrict the displacement of the door in the vehicle width direction.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle door device, comprising:
first and second link arms each having a first pivot connection point with respect to a vehicle body and a second pivot connection point with respect to a door of a vehicle;
a door side fitting portion provided at a closing side end portion of the door that opens and closes a door opening portion of the vehicle based on an operation of a link mechanism formed by the first and second link arms; and
a vehicle body side fitting portion provided at a closing side end portion of the door opening portion with and from which the closing side end portion of the door comes in contact and separates based on an opening or closing operation of the door;
wherein one side of the door side fitting portion and the vehicle body side fitting portion comprises a male fitting member having a fitting protrusion protruding in a direction in which the closing side end portion of the door and the closing side end portion of the door opening portion come in contact with and separate from each other;
the other side of the door side fitting portion and the vehicle body side fitting portion comprises a female fitting member having a fitting recess into and from which the fitting protrusion is inserted and removed based on an opening or closing operation of the door; and when the door is at a fully closed position, the male fitting member and the female fitting member are fitted to each other, so that relative displacement in a direction intersecting an insertion or removal direction of the fitting protrusion with respect to the fitting recess can be restricted.

2. The vehicle door device according to claim 1, comprising:
a door side engagement portion provided at the closing side end portion of the door; and
a vehicle body side engagement portion provided at the closing side end portion of the door opening portion; wherein
one side of the door side engagement portion and the vehicle body side engagement portion comprises a guide engagement portion;
the other side of the door side engagement portion and the vehicle body side engagement portion comprises a guide groove having a pair of side wall portions facing each other and extending in an opening or closing operation direction of the door; and
in a vicinity of a fully closed position of the door where the door side engagement portion and the vehicle body side engagement portion are engaged with each other, in a state where the guide engagement portion is disposed in the guide groove to guide the opening or closing operation of the door, the fitting protrusion of the male fitting member and the fitting recess of the female fitting member are inserted and removed.

3. The vehicle door device according to claim 2, wherein
the door side fitting portion and the door side engagement portion are integrally formed, and the vehicle body side fitting portion and the vehicle body side engagement portion are integrally formed.

4. The vehicle door device according to claim 2, wherein
the guide engagement portion is configured as a roller disposed between the pair of side wall portions in a state of being rotatably supported around a support shaft.

5. The vehicle door device according to claim 3 comprising
the male fitting member and the female fitting member configured to be able to restrict the relative displacement in a horizontal direction intersecting the insertion or removal direction.

6. The vehicle door device according to claim 4, comprising
the male fitting member and the female fitting member configured to be able to restrict the relative displacement in a horizontal direction intersecting the insertion or removal direction.

7. The Vehicle door device according to claim 3, comprising
the male fitting member and the female fitting member configured to be able to restrict the relative displacement in a vertical direction intersecting the insertion or removal direction.

8. The vehicle door device according to claim 4, comprising
the male fitting member and the female fitting member configured to be able to restrict the relative displacement in a vertical direction intersecting the insertion or removal direction.

9. The vehicle door device according to claim 1, comprising
a plurality of sets of the male fitting member and the female fitting member having different directions in which the relative displacement is restricted.

10. The vehicle door device according to claim 1, wherein
at least one of the door side fitting portion and the vehicle body side fitting portion comprises a bracket configured to support one of the male fitting member and the female fitting member on an installation surface, and comprises
a support position adjustment mechanism configured to enable adjustment of a support position of the fitting member by the bracket.

11. The vehicle door device according to claim 1, not comprising
a locking device configured to restrain the closing side end portion of the door to the closing side end portion of the door opening portion.

12. The vehicle door device according to claim 1, comprising
a buffer member interposed between the door side fitting portion and the vehicle body side fitting portion in a state where the male fitting member and the female fitting member are fitted to each other.

13. The vehicle door device according to claim 1, wherein
at least one of the first and second link arms is provided with a variable connection length mechanism capable of changing a connection length between the first and second pivot connection points.

14. The vehicle door device according to claim 1, comprising an actuator configured to apply a driving force to the link mechanism to open and close the door.
